(19) United States
(12) Patent Application Publication
(10) Pub. No.: US 2026/0158390 A1
(43) Pub. Date: Jun. 11, 2026

(54) DATA PROCESSING FOR VIRTUAL OBJECT COLLISION AVOIDANCE

(71) Applicant: Tencent Technology (Shenzhen) Company Limited, Shenzhen (CN)

(72) Inventor: Huiliang HUANG, Shenzhen (CN)

(73) Assignee: Tencent Technology (Shenzhen) Company Limited, Shenzhen, GD (CN)

(21) Appl. No.: 19/181,033

(22) Filed: Apr. 16, 2025

Related U.S. Application Data
(63) Continuation of application No. PCT/CN2023/133377, filed on Nov. 22, 2023.

(30) Foreign Application Priority Data
Jan. 28, 2023 (CN) 202310042502.X

(51) Int. Cl. A63F 13/577; G06F 16/901

(52) U.S. Cl. CPC A63F 13/577; G06F 16/9027

(57) ABSTRACT

In a data processing method, candidate virtual objects located in an initial collision cache region of a first virtual object in a target scene are obtained. A second virtual object at a distance from the first virtual object that is less than or equal to a collision distance of the first virtual object is obtained from the candidate virtual objects. An obstacle-space binary tree of the target scene is obtained. A collision region boundary of the first virtual object is determined by traversing nodes in the obstacle-space binary tree. Each of the nodes corresponds to an obstacle region boundary that includes a boundary line of an obstacle region in the target scene. An updated moving speed of the first virtual object is predicted based on the second virtual object and the collision region boundary. Movement of the first virtual object is controlled based on the updated moving speed.

### RELATED APPLICATIONS

The present application is a continuation of International Application No. PCT/CN2023/133377, filed on Nov. 22, 2023, which claims priority to Chinese Patent Application No. 202310042502.X, filed on Jan. 28, 2023. The entire disclosures of the prior applications are hereby incorporated by reference.

### FIELD OF THE TECHNOLOGY

This application relates to the field of computer technologies, including a data processing method.

### BACKGROUND OF THE DISCLOSURE

A current development trend of games is to construct a large open world, and interaction of a player in the large open world affects a terrain of a scene. To better control movement of a virtual object, collision-avoidance pathfinding needs to be performed on the virtual object. Currently, overall space of a target scene is divided into a plurality of convex polygons based on a terrain layout of the target scene. Adjacent convex polygons are connected via shared edges, and the plurality of convex polygons include a passable region and an impassable region. This is equivalent to forming a scene map of the target scene. Further, a connected polygon path between a polygon in which a start point is located and a polygon in which an end point is located is calculated based on terrain division regions (that is, the convex polygons), and the connected polygon path is optimized, to obtain a final polygon path. A location of a virtual object is updated frame by frame based on the final polygon path, to implement movement of the virtual object. However, in this manner, related data of the terrain division regions needs to be generated in advance. As a result, when the terrain layout of the target scene changes, the scenario map of the target scene needs to be constructed again based on a new terrain layout, and then a connected polygon path is calculated, causing low pathfinding efficiency.

### SUMMARY

Aspects of this disclosure include a data processing method, an apparatus, and a non-transitory computer-readable storage medium, which can improve pathfinding efficiency of a virtual object. Examples of technical solution of this disclosure may be implemented as follows:

An aspect of this disclosure provides a data processing method. Candidate virtual objects located in an initial collision cache region of a first virtual object in a target scene are obtained. A second virtual object at a distance from the first virtual object that is less than or equal to a collision distance of the first virtual object is obtained from the candidate virtual objects. An obstacle-space binary tree of the target scene is obtained. A collision region boundary of the first virtual object is determined by traversing nodes in the obstacle-space binary tree. Each of the nodes corresponds to an obstacle region boundary that includes a boundary line of an obstacle region in the target scene. An updated moving speed of the first virtual object is predicted based on the second virtual object and the collision region boundary. Movement of the first virtual object is controlled based on the updated moving speed.

An aspect of this disclosure provides a data processing apparatus. The apparatus includes processing circuitry configured to obtain candidate virtual objects located in an initial collision cache region of a first virtual object in a target scene. The processing circuitry is configured to obtain, from the candidate virtual objects, a second virtual object at a distance from the first virtual object that is less than or equal to a collision distance of the first virtual object. The processing circuitry is configured to obtain an obstacle-space binary tree of the target scene. The processing circuitry is configured to determine a collision region boundary of the first virtual object by traversing nodes in the obstacle-space binary tree. Each of the nodes corresponds to an obstacle region boundary that includes a boundary line of an obstacle region in the target scene. The processing circuitry is configured to predict an updated moving speed of the first virtual object based on the second virtual object and the collision region boundary. The processing circuitry is configured to control movement of the first virtual object based on the updated moving speed.

An aspect of this disclosure provides a non-transitory computer-readable storage medium storing instructions which when executed by a processor cause the processor to perform any of the methods of this disclosure.

When the aspects of this disclosure are performed, the following beneficial effects can be achieved:

In the aspects of this disclosure, the candidate virtual object located in the initial collision cache region of the first virtual object may be obtained, the second virtual object associated with the first virtual object is obtained from the candidate virtual object, and the candidate virtual object of the first virtual object is stored by using the cache. This is equivalent to initial virtual-object screening. The initial collision cache region is the to-be-detected grid index corresponding to the first virtual object in the object management array, and the object management array is configured for representing the location that is of the virtual object included in the target scene and that is in the unit grid into which the target scene is divided, so that a computer device can conveniently and quickly index the candidate virtual object in the object management array, to further reduce searching duration required for obtaining the second virtual object, and improve virtual-object screening efficiency. In addition, the unit grid is obtained through dividing based on only the location in the target scene, and is not affected by a terrain layout of the target scene, so that generation of the unit grid does not need to be changed for many times, and the unit grid can even be applied to different scenes. Therefore, construction efficiency and convenience of the unit grid can be improved. In addition, the obstacle-space binary tree of the target scene in which the first virtual object is located may be obtained, the nodes in the obstacle-space binary tree are traversed, and the target obstacle region boundary corresponding to the node whose distance to the first virtual object is less than or equal to the collision distance is determined as the collision region boundary of the first virtual object. The node in the obstacle-space binary tree corresponds to the obstacle region boundary in the target scene. A difference between a quantity of first direction child nodes corresponding to any node in the obstacle-space binary tree and a quantity of second direction child nodes corresponding to the node is less than or equal to the boundary division threshold. In other words, quantities of child nodes of any node in the obstacle-region binary tree in two directions are similar. Therefore, traversing on the obstacle-space binary tree is similar to binary search, so that efficiency of screening the obstacle region is improved. Further, the updated moving speed of the first virtual object may be predicted based on the obtained second virtual object and the collision region boundary, and the first virtual object is controlled based on the updated moving speed to move. According to the foregoing process, efficiency of the operations of obtaining the updated moving speed is improved, to further improve pathfinding efficiency.

### BRIEF DESCRIPTION OF THE DRAWINGS

To describe the technical solutions in aspects of this disclosure, the accompanying drawings are briefly described below.

FIG. 1 is a diagram of a network interaction architecture of data processing according to an aspect of this disclosure.

FIG. 2 is a scenario of a data processing scenario according to an aspect of this disclosure.

FIG. 3 is a flowchart of a data processing method according to an aspect of this disclosure.

FIG. 4 is a schematic diagram of a scenario of generating an object management array according to an aspect of this disclosure.

FIG. 5 is a schematic diagram of another scenario of generating an object management array according to an aspect of this disclosure.

FIG. 6 is a schematic diagram of an obstacle-space binary tree according to an aspect of this disclosure.

FIG. 7 is a schematic diagram of a scene according to an aspect of this disclosure.

FIG. 8 is a schematic diagram of a speed update scenario according to an aspect of this disclosure.

FIG. 9 is a schematic diagram of a scenario of constructing a speed region according to an aspect of this disclosure.

FIG. 10 is a schematic diagram of iteration duration according to an aspect of this disclosure.

FIG. 11 is a schematic diagram of a tree-construction test result according to an aspect of this disclosure.

FIG. 12 is a schematic diagram of a data processing apparatus according to an aspect of this disclosure.

FIG. 13 is a schematic diagram of a structure of a computer device according to an aspect of this disclosure.

### DETAILED DESCRIPTION

Technical solutions in aspects of this disclosure are described below with reference to the accompanying drawings. The described aspects are some of the aspects of this disclosure, rather than all of the aspects. Based on the aspects of this disclosure, other aspects o are within the scope of this disclosure. Further, the descriptions of the terms are provided as examples only and are not intended to limit the scope of the disclosure.

In this disclosure, if data of an object (such as a user) needs to be collected, before or during collection, a prompt interface or a pop-up window is displayed. The prompt interface or the pop-up window is configured for prompting the user that the data is currently collected. Operations related to data obtaining start to be performed only after a confirmation operation of the user for the prompt interface or the pop-up window is obtained; otherwise, the operations end. In addition, the obtained user data is used in a scenario, an objective, or the like that is rational and legal. In some aspects, in some scenarios in which user data needs to be used but user authorization is not obtained, authorization may further be requested from the user, and the user data is used after the authorization passes.

Pathfinding is a process of calculating a communication path between two locations in space. A navigation grid is data description that is performed by using convex polygons and that is performed on a surface (namely, a passable region in a target scene) that is of space (such as the target scene) and on which pathfinding can be performed. Collision avoidance is dodging another virtual object and an obstacle region in a moving process of a virtual object, to avoid overlapping of the virtual object with the another virtual object or obstacle region. The obstacle region may refer to an impassable region, for example, a region in which an obstacle in the target scene is located. A dynamic obstacle region is an impassable region added or deleted from the target scene at any time, for example, a region in which an obstacle added or deleted from the target scene at any time is located. The passable region is a region in which the virtual object can pass and perform pathfinding. The impassable region is a region in which the virtual object cannot pass nor perform pathfinding. The virtual object may be considered as a game character controlled by a player by using a computer device.

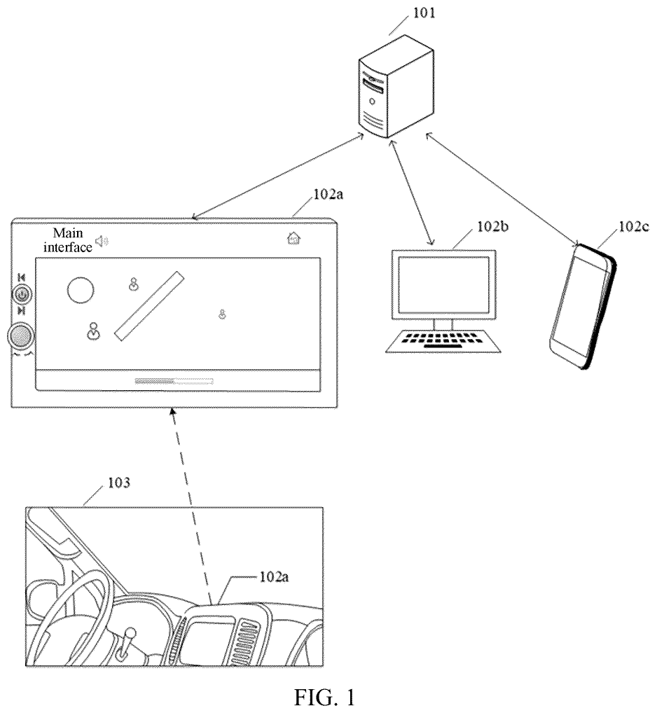

In the aspects of this disclosure, FIG. 1 is a diagram of a network interaction architecture of data processing according to an aspect of this disclosure. As shown in FIG. 1, a user may enter a target scene by using a computer device, the computer device may control movement of a virtual object in the target scene, and the virtual object may be considered as a character of the user in the computer device. Any computer device may perform data interaction with another computer device such as a computer device 102a, a computer device 102b, or a computer device 102c, or may perform data interaction with the another computer device by using a server 101. A computer device on which a first virtual object is located may obtain a second virtual object near the first virtual object and a collision region boundary. The second virtual object is a virtual object whose distance to the first virtual object is less than or equal to a collision distance of the first virtual object, that is, a virtual object that may collide with the first virtual object. The collision region boundary of the first virtual object is a boundary of an obstacle region whose distance to the first virtual object is less than or equal to the collision distance, that is, a boundary of an obstacle region that may collide with the first virtual object. Further, the computer device may predict an updated moving speed of the first virtual object based on the second virtual object and the collision region boundary, and control, based on the updated moving speed, the first virtual object to move.

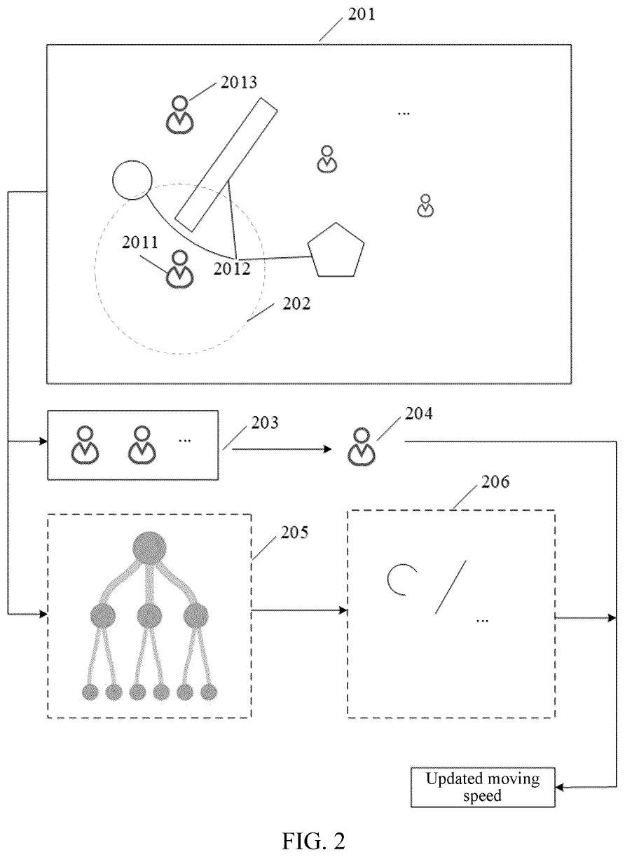

Specifically, FIG. 2 is a schematic diagram of a data processing scenario according to an aspect of this disclosure. As shown in FIG. 2, a first virtual object 2011, an obstacle region 2012, and a virtual object other than the first virtual object 2011, such as a virtual object 2013, exist in a target scene 201. Specifically, a computer device may obtain candidate virtual objects 203 located in an initial collision cache region 202 of the first virtual object 2011. The initial collision cache region 202 is a region configured for performing coarse collision screening on the first virtual object 2011, and a second virtual object 204 may be obtained from the candidate virtual objects 203. A distance between the second virtual object 204 and the first virtual object 2011 is less than or equal to a collision distance of the first virtual object. Through the foregoing coarse collision screening, a quantity of virtual objects on which distance comparison with the first virtual object needs to be performed is reduced, and duration for obtaining a virtual object that may collide is reduced. Then, the second virtual object that may collide with the first virtual object is determined based on the collision distance, to improve accuracy of obtaining the virtual object, and further improve efficiency of obtaining the virtual object.

The computer device may obtain an obstacle-space binary tree 205 of the target scene 201 in which the first virtual object 2011 is located, traverse nodes in the obstacle-space binary tree 205, obtain, in a boundary region boundary corresponding to the node, a target obstacle region boundary whose distance to the first virtual object 2011 is less than or equal to the collision distance, and determine the target obstacle region boundary as a collision region boundary 206 of the first virtual object 2011. A difference between a quantity of obstacle region boundaries included in a first direction subtree of any node in the obstacle-space binary tree 205 and a quantity of obstacle region boundaries included in a second direction subtree of the node is less than or equal to a boundary division threshold. In other words, the obstacle-space binary tree 205 may be considered as a tree in which a quantity of obstacle region boundaries in left and right subtrees of any node is balanced. In addition, a relative location between a child node in a subtree of any master node (which may also be referred to as a parent node) and the master node (where the relative location may be understood as that the child node is in a subtree on a right side or a left side of the parent node) may be considered to be the same as a relative location between an obstacle region boundary corresponding to the master node and an obstacle region boundary corresponding to the child node in the subtree of the master node. For example, a node A includes a child node 1 and a child node 2. The child node 1 is located in a first direction subtree of the node A, and the child node 2 is located in a second direction subtree of the node A. In this case, it may be considered that an obstacle region boundary corresponding to the child node 1 is located on a first directional side (which is the same as a direction of the first direction subtree, for example, both are on a left side) of an obstacle region boundary corresponding to the node A, and an obstacle region boundary corresponding to the child node 2 is located on a second directional side (which is the same as a direction of the second direction subtree, for example, both are on a right side) of the obstacle region boundary corresponding to the node A. Any node in the obstacle-space binary tree may be referred to as a master node, and a node in a subtree of the master node may be considered as a child node of the master node. In other words, when a leaf node in the obstacle-space binary tree is used as a master node, there is no child node. When a root node in the obstacle-space binary tree is used as a master node, all nodes other than the root node in the obstacle-space binary tree may be considered as child nodes. Efficiency of obtaining an obstacle region boundary that may collide with the first virtual object can be improved by using the obstacle-space binary tree.

The computer device may construct the obstacle-space binary tree based on an obstacle region boundary in the target scene. Specifically, the computer device may obtain obstacle region boundaries of an obstacle region included in the target scene, traverse the obstacle region boundaries, and when finding a first obstacle region boundary, construct a first root node based on the first obstacle region boundary. A quantity difference between obstacle region boundaries on directional sides of the first obstacle region boundary is less than or equal to the boundary division threshold. The computer device divides the obstacle region boundaries into N boundary sets based on N directional sides of the first obstacle region boundary. N is a positive integer, and obstacle region boundaries included in each boundary set are located on a same directional side of the first obstacle region boundary. If a boundary quantity of obstacle region boundaries included in an ith boundary set is greater than a tree construction threshold, the computer device traverses the ith boundary set, searches for a second obstacle region boundary in the ith boundary set, and constructs an ith child node of the first root node based on the second obstacle region boundary in the ith boundary set until obtaining an ith subtree of the first root node. i is a positive integer less than or equal to N. If a boundary quantity of obstacle region boundaries included in an ith boundary set is less than or equal to a tree construction threshold, the computer device constructs an ith child node of the first root node based on the ith boundary set, and determines the ith child node of the first root node as an ith subtree of the first root node. When obtaining N subtrees of the first root node, the computer device constructs the first root node and the N subtrees of the first root node as the obstacle-space binary tree. The obstacle-space binary tree is configured for performing collision detection on a virtual object.

Further, an updated moving speed of the first virtual object may be predicted based on the second virtual object and the collision region boundary, and the first virtual object is controlled based on the updated moving speed to move. Operations in the process of obtaining the updated moving speed is optimized, to further improve pathfinding efficiency of the first virtual object.

The computer device described in this aspect of this disclosure includes, but is not limited to, a terminal device or a server. In other words, the computer device may be a server or a terminal device, or may be a system including a server and a terminal device. The terminal device mentioned above may be an electronic device, which includes, but is not limited to, a mobile phone, a tablet computer, a desktop computer, a notebook computer, a palmtop computer, a vehicle-mounted device, an augmented reality/virtual reality (AR/VR) device, a helmet display, a smart television, a wearable device, a smart speaker, a digital camera, a camera, and another mobile internet device (MID) having a network access capability, or a terminal device in scenarios such as a train, a ship, and flight. As shown in FIG. 1, the terminal device may be a notebook computer (as shown by the computer device 102b), a mobile phone (as shown by the computer device 102c), a vehicle-mounted device (as shown by the computer device 102a), or the like. FIG. 1 merely shows some devices. In some aspects, the computer device 102a is a device located in a vehicle 103. The computer device 102a may be configured to enter a target scene, for example, may participate in a target game. The target scene is any scene in the target game. The target game may be any game in which pathfinding may be performed. The foregoing described server may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, vehicle infrastructure cooperation, a content delivery network (CDN), big data, and an artificial intelligence platform.

In some aspects, the data involved in this aspect of this disclosure may be stored in a computer device, or may be stored by using a cloud storage technology or a blockchain network. This is not limited herein.

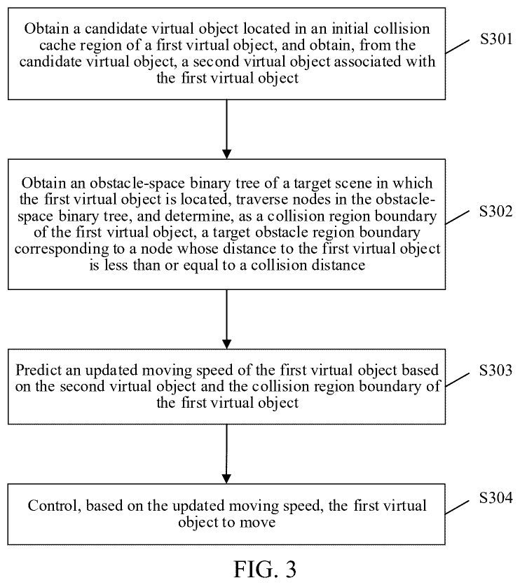

FIG. 3 is a schematic flowchart of a data processing method according to an aspect of this disclosure. As shown in FIG. 3, the data processing method includes the following operations.

Operation S301: Obtain candidate virtual objects located in an initial collision cache region of a first virtual object, and obtain, from the candidate virtual objects, a second virtual object associated with the first virtual object. For example, candidate virtual objects located in an initial collision cache region of a first virtual object in a target scene are obtained. A second virtual object at a distance from the first virtual object that is less than or equal to a collision distance of the first virtual object is obtained from the candidate virtual objects.

In this aspect of this disclosure, a computer device may obtain the candidate virtual objects located in the initial collision cache region of the first virtual object. The initial collision cache region is a region configured for performing coarse collision screening on the first virtual object. The initial collision cache region is a to-be-detected grid index corresponding to the first virtual object in an object management array, or a region configured for constructing a collision object cache of the first virtual object. A distance between the second virtual object and the first virtual object is less than or equal to a collision distance of the first virtual object. In some aspects, the object management array may also be stored in the collision object cache. Therefore, a virtual object included in the object management array may also be understood as a virtual object stored in the collision object cache. The object management array is configured for representing a grid index corresponding to a virtual object included in a target scene. The grid index is configured for representing a location of the virtual object in a unit grid into which the target scene is divided. The target scene includes the first virtual object. The candidate virtual object is a virtual object in an array element indicated by the to-be-detected grid index in the object management array.

Specifically, in a manner, the computer device may obtain first location information of the first virtual object and the collision distance of the first virtual object, and fuse the first location information and the collision distance, to obtain a collision detection range of the first virtual object. For example, the first virtual object is denoted as agent A, and the first location information of the first virtual object is obtained. The first location information may be a location of dim dimensions. dim is a positive integer, and is a space dimension of the target scene. If the target scene is two-dimensional space, dim is 2, and the first location information may be considered as (x₁, z₁). If the target scene is a three-dimensional space, dim is 3, and the first location information may be considered as (x₁, y₁, z₁). The rest can be deduced by analogy. The computer device may obtain the collision distance radius of the first virtual object. The collision distance is a distance at which there is a possibility of colliding with the first virtual object. In other words, a virtual object whose distance to the first virtual object is less than or equal to the collision distance has a possibility of colliding with the first virtual object.

Further, the computer device may fuse the first location information and the collision distance, to obtain the collision detection range of the first virtual object. To be specific, the computer device may construct the collision detection range by using the first location information as a circle center and the collision distance of the first virtual object as a radius. A dimension of the collision detection range may be determined based on the space dimension of the target scene. If the target scene is two-dimensional space, that is, the space dimension dim is 2, the dimension of the collision detection range may be 2. If the target scene is a three-dimensional space, that is, the space dimension dim may be 2 or 3, the dimension of the collision detection range may be 2 or 3. Alternatively, the computer device may obtain dimensional locations of the first location information in h to-be-detected dimensions; determine ranges of the h dimensional locations based on the collision distance, to obtain dimensional ranges respectively corresponding to the h to-be-detected dimensions; and construct the collision detection range based on the dimensional ranges respectively corresponding to the h to-be-detected dimensions, where h is a positive integer less than or equal to dim. For example, h is 2. The computer device may determine a first dimensional range in a first dimension based on a first dimensional location in the first dimension in the first location information and the collision distance; determine a second dimensional range in a second dimension based on a second dimensional location in the second dimension in the first location information and the collision distance; and construct the collision detection range based on the first dimensional range and the second dimensional range. For example, the first dimensional range is [x₁−radius, x₁+radius], and the second dimension range is [z₁−radius, z₁+radius]. Alternatively, it may be considered that first location conversion is performed on the first location information based on the collision distance, to obtain a first range boundary. For example, if the first location conversion is subtraction, and h is 2, the first range boundary may be denoted as [x_low, z_low]. x_low=x₁-radius, and z_low=z₁−radius. Second location conversion is performed on the first location information based on the collision distance, to obtain a second range boundary. For example, if the second location conversion is addition, and h is 2, the second range boundary may be denoted as [x_up, z_up], x_up=x₁+radius, and z_up=z₁+radius.

Further, the computer device may obtain a unit length of the unit grid of the target scene. For example, the unit length may be denoted as (x_uint, z_uint). Grid conversion is performed on the collision detection range based on the unit length, to obtain a grid detection range. For example, the grid detection range is determined based on the first range boundary and the second range boundary. In this case, the grid detection range includes a first detection boundary and a second detection boundary. For a process of obtaining the first detection boundary, refer to a formula \textcircled{1}:

$$( grid\_x \_low , grid\_z \_low ) = ( ( {x}_{1} - radius ) / x\_uint , ( {z}_{1} - radius ) / z\_uint ) ] \qquad 1$$

As shown in the formula \textcircled{1}, the first detection boundary is (grid_x_low, grid_z_low).

For a process of obtaining the second detection boundary, refer to a formula \textcircled{2}:

$$( grid\_x \_up , grid\_z \_up ) = ( ( {x}_{1} + radius ) / x\_uint , ( {z}_{1} - radius ) / z\_uint ) ] \qquad 2$$

As shown in the formula (2), the second detection boundary is (grid_x_up, grid_z_up).

Further, the computer device may perform Hash conversion on the grid detection range, to obtain the initial collision cache region of the first virtual object. Specifically, a unit grid located in the grid detection range may be obtained, and the unit grid located in the grid detection range is denoted as a to-be-detected unit grid. An example in which h is 2 is used below. Grid location information of the to-be-detected unit grid may be denoted as (grid_x, grid_z). The to-be-detected unit grid satisfies (grid_x_low≤grid_x≤grid_x_up, grid_z_low≤grid_z≤grid_z_up). Hash conversion is performed on the grid location information of the to-be-detected unit grid, to obtain the initial collision cache region of the first virtual object. In this case, the initial collision cache region is the to-be-detected grid index corresponding to the first virtual object in the object management array. Hash conversion may be performed on the grid location information of the to-be-detected unit grid based on a Hash function, to obtain the initial collision cache region of the first virtual object. The Hash function may be denoted as grid_hash_func (parameters respectively corresponding to the h to-be-detected dimensions, N). If h is 2, the Hash function is grid_hash_func (parameter 1, parameter 2, N). N is a positive integer, and N is an array dimension of the object management array. In other words, the Hash conversion may be denoted as grid_hash_func (grid_x, grid_z, N). Hash conversion may be performed on the grid location information of the to-be-detected unit grid based on the Hash function, to obtain a to-be-detected grid index k corresponding to the first virtual object, and the to-be-detected grid index k is determined as the initial collision cache region of the first virtual object. Further, a virtual object corresponding to the initial collision cache region in the object management array may be determined as the candidate virtual object. In other words, a virtual object in an array element indicated by the to-be-detected grid index in the object management array is determined as the candidate virtual object.

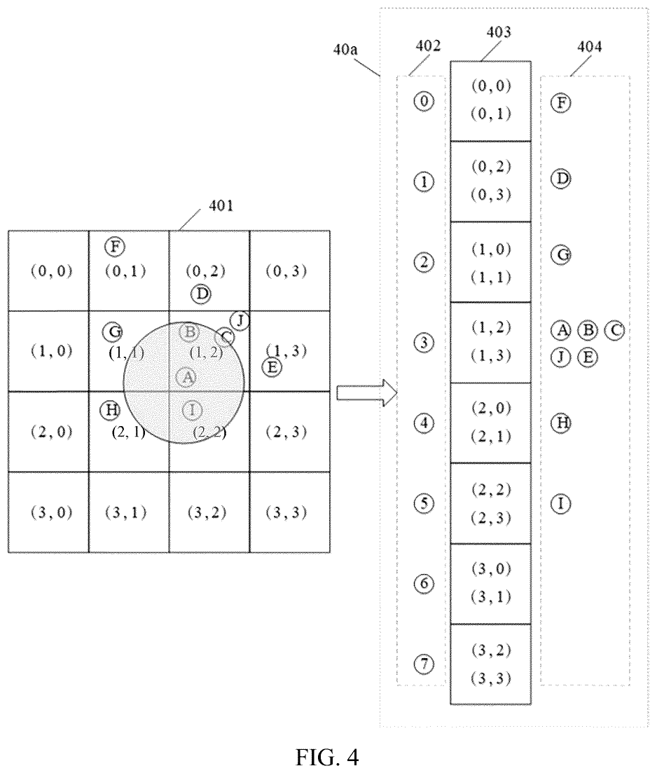

For example, it is assumed that the Hash function grid_hash_func (parameter 1, parameter 2, N)=(2*parameter 1+parameter 2) % N, and N is 8. It is assumed that N is 8, and is an assumed value. A value of N may alternatively change based on a quantity of unit grids or a user requirement. [unit grid (0, 0), unit grid (0, 1), unit grid (0, 2), unit grid (0, 3), unit grid (1, 0), unit grid (1, 1), unit grid (1, 2), unit grid (1, 3), unit grid (2, 0), unit grid (2, 1), unit grid (2, 2), unit grid (2, 3), . . . ] exists. Grid indexes respectively corresponding to the unit grids are sequentially 0, 1, 2, 3, 2, 3, 4, 5, 4, 5, 6, 7, . . . . In this manner, a unit grid may be mapped to and associated with a grid index of the object management array, so that a virtual object included in any unit grid is associated with and cached to a grid index mapped to and associated with the unit grid. Refer to FIG. 4. It is assumed that the first virtual object is located in the unit grid (1, 2), and an obtained to-be-detected unit grid includes [unit grid (1, 1), unit grid (1, 2), unit grid (2, 1), unit grid (2, 2)]. Hash conversion is performed on grid location information of the to-be-detected unit grid based on the Hash function, to obtain a to-be-detected grid index k, where k includes [3, 4, 5, 6]. A virtual object in an array element corresponding to the to-be-detected grid index k is obtained from the object management array as the candidate virtual object. For example, the object management array is denoted as a grid (8), that is, an eight-dimensional array. In this case, the candidate virtual objects are values of a grid [3], a grid [4], a grid [5], and a grid [6]. The superscript (8) is configured for representing an array dimension of the object management array, and the superscript [ ] is configured for representing a grid index in the object management array. For example, [3] represents a grid index “3” in the object management array.

Alternatively, the computer device may obtain a unit grid located in the grid detection range; denote, as a to-be-detected unit grid, the unit grid located in the grid detection range; denote, as a to-be-detected grid index, that is, the initial collision cache region of the first virtual object, a grid index that is of grid location information corresponding to the to-be-detected unit grid and that is in the object management array; and determine, as the candidate virtual object, a virtual object corresponding to the initial collision cache region in the object management array. In other words, the computer device may cache an association relationship between grid location information of a unit grid included in the target scene and a grid index in the object management array. Any association relationship may be denoted as (grid location information, grid index). The computer device may determine, based on the association relationship, the grid location information corresponding to a to-be-detected unit grid, to determine, in the object management array, the grid index associated with the grid location information. For example, FIG. 4 is a schematic diagram of a scenario of generating an object management array according to an aspect of this disclosure. As shown in FIG. 4, an object management array 40a shown in FIG. 4 is used as an example. It is assumed that the first virtual object is a virtual object A, and the object management array 40a is denoted as a grid (8), that is, for example, N is 8. The object management array 40a includes an association relationship between a grid index 402 and a unit grid 403. It is assumed that an obtained to-be-detected unit grid includes [unit grid (1, 1), unit grid (1, 2), unit grid (2, 1), unit grid (2, 2)]. A to-be-detected grid index k corresponding to the to-be-detected unit grid is obtained based on the association relationship between the grid index 402 and the unit grid 403. In this case, k includes [2, 3, 4, 5]. Virtual objects corresponding to the to-be-detected grid index k are obtained from the object management array 40a as candidate virtual objects. The candidate virtual objects include (a virtual object G, a virtual object A, a virtual object B, a virtual object C, a virtual object J, a virtual object E, a virtual object H, and a virtual object I).

The initial collision cache region is the to-be-detected grid index corresponding to the first virtual object in the object management array, and the object management array is configured for representing the location that is of the virtual object included in the target scene and that is in the unit grid into which the target scene is divided, so that a computer device can conveniently and quickly index the candidate virtual object in the object management array, to further reduce searching duration required for obtaining the second virtual object, and improve virtual-object screening efficiency. In addition, the unit grid is obtained through dividing based on only the location in the target scene, and is not affected by a terrain layout of the target scene, so that generation of the unit grid does not need to be changed for many times, and the unit grid can even be applied to different scenes. Therefore, construction efficiency and convenience of the unit grid can be improved.

The unit grid is obtained by dividing a scene map of the target scene. In other words, a region included in each unit grid has range space. Therefore, when each virtual object moves, a unit grid in which each virtual object is located does not change in real time, but the virtual object may move from a unit grid to another unit grid after particular duration. In this way, the object management array does not change within the particular duration, and the object management array does not need to be updated in real time, so that time can be saved, and efficiency and convenience of performing collision detection on the virtual object can be improved. A virtual object that requires accurate detection is deleted by using the object management array, to reduce a data amount for performing collision detection on the virtual object, and further improve pathfinding efficiency to some extent.

Further, the computer device may create the object management array. The object management array is an array configured for managing a virtual object included in the target scene, that is, configured for indicating the location of the virtual object included in the target scene in the unit grid into which the target scene is divided. Specifically, the target scene may be constructed into M unit grids based on the unit length of the unit grid, and grid location information respectively corresponding to the M unit grids is initialized, M being a positive integer. Using h being 2 as an example, the unit length of the unit grid is denoted as (x_uint, z_uint). To be specific, a unit length of an x-axis is x_uint, and a unit length of a z-axis is z_uint. Further, an N-dimensional initial object management array may be created, and Hash conversion is performed on the grid location information respectively corresponding to the M unit grids, to obtain grid indexes respectively corresponding to the M unit grids, N being a positive integer. In some aspects, the array dimension N may be determined based on the quantity M of unit grids, or a default array dimension may be determined as the array dimension N, or the array dimension N may be obtained from an integer exponent of 2. This is not limited herein. The computer device obtains the unit grid in which the virtual object included in the target scene is located, and adds the virtual object to the initial object management array based on a grid index of the unit grid in which the virtual object is located, to obtain the object management array; or may obtain location information of the virtual object included in the target scene, perform grid conversion on the location information of the virtual object based on the unit length, to determine a first grid location corresponding to the virtual object, perform Hash conversion on the first grid location, to determine a grid index of the virtual object, and add the virtual object to the initial object management array based on the grid index of the virtual object, to obtain the object management array. In this manner, the virtual object in the target scene is mapped to the constructed unit grid, so that the object management array can represent a location of each virtual object relative to the unit grid. The unit grid divides the target scene, and reduces a quantity of coordinates in the target scene (where to be specific, coordinates of each location point in the target scene are reduced to coordinates of each unit grid). Therefore, an amount of data that needs to be processed when the coordinates in the target scene are mapped to the object management array is reduced, so that duration consumed to initially screen the virtual object based on the object management array is reduced to some extent, and object detection efficiency is improved. The initial collision cache region is configured for indicating a grid index obtained based on conversion of the grid detection range, that is, the to-be-detected grid index. The virtual object includes the candidate virtual object. In other words, the unit grid obtained by dividing the target scene is related to only the location in the target scene, but is not related to the terrain layout of the target scene. Therefore, even if the terrain layout of the target scene changes, division of the unit grid in the target scene does not need to be changed, so that efficiency and convenience of constructing the unit grid can be improved.

When the grid location information respectively corresponding to the M unit grids is initialized, second location information of grid identification points respectively corresponding to the M unit grids may be obtained, and location gridding conversion is performed, based on the unit length, on the second location information respectively corresponding to the M unit grids, to obtain the grid location information respectively corresponding to the M unit grids. The grid identification point may be a center point of a unit grid in which the grid identification point is located. Using one unit grid as an example, a grid identification point corresponding to the unit grid may be denoted as center. Using h being 2 as an example, second location information of the grid identification point may be (center_x, center_z). Gridding conversion is performed on the second location information of the unit grid, to obtain grid location information (center_x/x_uint, center_z/z_uint) of the unit grid.

For example, referring to FIG. 4, M unit grids 401 are constructed, including a unit grid (0, 1), . . . , a unit grid (3, 3), and the like. Hash conversion is performed on grid location information respectively corresponding to the M unit grids 401, to obtain grid indexes respectively corresponding to the M unit grids 401, for example, an association relationship between a grid index 402 and a unit grid 403. The computer device may add the virtual object in the target scene to an array element at a grid index of a unit grid in which the virtual object is located, to generate the object management array 40a. The object management array 40a may include the grid index 402 and an array element 404 indicated by the grid index. Each array element is configured for storing a virtual object located in the array element, and the virtual object in the array element is also located in a unit grid corresponding to a grid index associated with the array element. Alternatively, the object management array 40a may include the grid index 402, an array element 404 indicated by the grid index 402, and the unit grid 403 corresponding to the grid index 402. In other words, the object management array 40a may include a grid index, an array element corresponding to any grid index, and grid location information of a unit grid.

When a new virtual object enters the target scene, the newly added virtual object may be added to the object management array. Specifically, when a third virtual object (namely, a new virtual object) enters the target scene, third location information of the third virtual object in the target scene is obtained; grid conversion is performed on the third location information based on the unit length, to obtain an object grid location of the third virtual object, and Hash conversion is performed on the object grid location, to obtain a to-be-added grid index corresponding to the third virtual object; and the third virtual object is added to the object management array based on the to-be-added grid index. In this disclosure, Hash conversion is performed by using a same Hash conversion method. The Hash conversion method is not limited herein. In some aspects, the computer device may generate the object management array based on an array update cycle. In other words, for example, the computer device generates the object management array at a current moment, and regenerates the object management array when the array update cycle passes after the object management array is generated, so that the virtual object stored in the object management array may correspond to an actual location of the virtual object in the target scene. In other words, a virtual object that may collide with the first virtual object may be more accurately obtained, to improve, to some extent, accuracy of performing collision detection on the virtual object.

In a manner, the computer device may obtain the candidate virtual objects from a collision object cache associated with the first virtual object, the collision object cache being configured for storing a virtual object located in the initial collision cache region of the first virtual object. In other words, virtual objects corresponding to the to-be-detected grid index k in the object management array may be grouped into the collision object cache. The to-be-detected grid index k is the initial collision cache region of the first virtual object. In other words, a collision object cache may be maintained for any virtual object in the target scene. When a candidate virtual object of a virtual object needs to be obtained, a collision object cache of the virtual object may be obtained, and a virtual object included in the collision object cache is determined as the candidate virtual object of the virtual object.

When the first virtual object joins the target scene, the computer device may obtain a standard moving speed V and the collision distance R (namely, radius) of the first virtual object; and determine the initial collision cache region of the first virtual object based on the standard moving speed and the collision distance. The standard moving speed may be considered as a maximum moving speed of the first virtual object within a cache update cycle. For example, a sum of an integer multiple of the standard moving speed and the collision distance may be determined as a region radius, such as (2V+R), and the initial collision cache region is determined based on the region radius. Alternatively, a sum of the standard moving speed, the collision distance, and a range expansion length may be determined as a region radius, and the initial collision cache region is determined based on the region radius. This is not limited herein. The range expansion length is configured for expanding a range that needs to be cached, to improve fault tolerance of performing collision detection on the virtual object. Further, the virtual object included in the initial collision cache region is determined as the candidate virtual object associated with the first virtual object, and the candidate virtual object is added to the collision object cache associated with the first virtual object. The first virtual object may be simultaneously added to a collision object cache of the candidate virtual object. In other words, when the candidate virtual object has a possibility of colliding with the first virtual object, the collision object cache of the first virtual object may be synchronized. For example, if the collision object cache of the first virtual object includes a virtual object 1 and a virtual object 2, the first virtual object is added to a collision object cache of the virtual object 1 and a collision object cache of the virtual object 2.

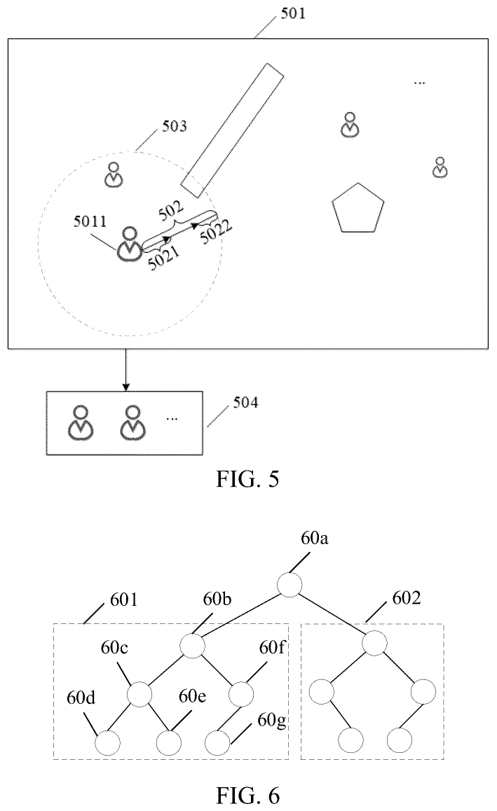

For example, FIG. 5 is a schematic diagram of another scenario of generating an object management array according to an aspect of this disclosure. As shown in FIG. 5, when a first virtual object 5011 joins a target scene 501, a standard moving speed 5021 (which may be referred to as V) and a collision distance 5022 (which may be referred to as R) of the first virtual object 5011 are obtained, and an initial collision cache region 503 of the first virtual object 5011 is determined based on the standard moving speed 5021 and the collision distance 5022. For example, (2V+R) is used as a region radius 502, and the initial collision cache region 503 of the first virtual object 5011 is determined based on the region radius 502 and first location information of the first virtual object 5011. A virtual object included in the initial collision cache region 503 is determined as a candidate virtual object associated with the first virtual object 5011, and the candidate virtual object is added to a collision object cache 504 associated with the first virtual object 5011.

In some aspects, if cache duration of the collision object cache of the first virtual object reaches a cache update cycle or location jumping occurs on the first virtual object, the collision object cache of the first virtual object is cleared, a current collision cache region of the first virtual object is obtained, and a virtual object included in the current collision cache region is added to the collision object cache of the first virtual object. The location jumping is that the first virtual object changes from a first location to a second location at a speed greater than a teleportation speed threshold, and is equivalent to location teleportation. When the first virtual object normally moves, a moving distance within 1 second is limited to a maximum moving speed. Therefore, the initial collision cache region determined based on the standard moving speed and the collision distance can enable the first virtual object to be still in the initial collision cache region after the first virtual object moves within the cache update cycle. For example, when the region radius is (2V+R), movement of another virtual object may be considered. In other words, for the candidate virtual object in the initial collision cache region, the movement of the first virtual object and the movement of the another virtual object other than the first virtual object may be considered. That is, the candidate virtual object may include a virtual object that may collide with the first virtual object at each time point when the first virtual object moves within the cache update cycle, so that the collision object cache does not need to be updated in real time, thereby reducing a complete calculation frequency of the collision object cache, saving resources, and improving cache management efficiency. However, if location jumping occurs on the first virtual object, that is, a location of the first virtual object suddenly changes, location information of the first virtual object changes greatly, and consequently, the initial collision cache region of the first virtual object changes greatly. In this case, the collision object cache of the first virtual object may be updated, to ensure cache accuracy.

When the second virtual object associated with the first virtual object is obtained from the candidate virtual objects, candidate location information of the candidate virtual objects may be obtained, and first location information of the first virtual object is obtained. An object location distance between the candidate location information and the first location information is calculated. If the object location distance is less than or equal to the collision distance, the candidate virtual object is determined as the second virtual object associated with the first virtual object. The second virtual object includes no first virtual object. Both the candidate position information and the first location information may be considered as vectors of dim dimensions.

Operation S302: Obtain an obstacle-space binary tree of the target scene in which the first virtual object is located, traverse nodes in the obstacle-space binary tree, and determine, as a collision region boundary of the first virtual object, a target obstacle region boundary corresponding to a node whose distance to the first virtual object is less than or equal to the collision distance. For example, an obstacle-space binary tree of the target scene is obtained. A collision region boundary of the first virtual object is determined by traversing nodes in the obstacle-space binary tree. Each of the nodes corresponds to an obstacle region boundary that includes a boundary line of an obstacle region in the target scene.

In this aspect of this disclosure, the node in the obstacle-space binary tree corresponds to an obstacle region boundary in the target scene. A difference between a quantity of obstacle region boundaries included in a first direction subtree of any node in the obstacle-space binary tree and a quantity of obstacle region boundaries included in a second direction subtree of the node is less than or equal to a boundary division threshold. An obstacle region exists in the target scene, and a boundary line of the obstacle region may be considered as the obstacle region boundary. The obstacle region is a region in which an obstacle (such as a building body or a scene decoration) is located, and another impassable region (such as an ocean or a marsh), that is, an impassable region in the target scene. The building body is an impassable part of a building, such as a building wall. An obstacle region boundary is used as an example. If the obstacle region boundary is not segmented, the obstacle region boundary may be considered as an original obstacle region boundary. If the obstacle region boundary is segmented, a new obstacle region boundary is obtained after the obstacle region boundary is segmented. For example, if an obstacle region boundary A is segmented into two parts, it may be considered that the obstacle region boundary A is segmented into an obstacle region boundary A1, an obstacle region boundary A2, and the like. The obstacle region boundary A is an original obstacle region boundary. A relative location between a node (which may be denoted as a child node) in a subtree of any node (which may be denoted as a master node) in the obstacle-space binary tree and the master node is the same as a relative location between an obstacle region boundary corresponding to the master node and an obstacle region boundary corresponding to the node in the subtree of the master node. For details, refer to related descriptions in FIG. 2.

Specifically, the computer device may obtain an obstacle distance (which may be denoted as a first obstacle distance, and may also be referred to as a vertical distance) between the first virtual object and a straight line on which an obstacle region boundary corresponding to the root node in the obstacle-space binary tree is located. If the first obstacle distance is less than or equal to the collision distance, the obstacle region boundary corresponding to the root node is determined as the collision region boundary of the first virtual object, the first direction subtree and the second direction subtree of the root node are traversed, the target obstacle region boundary that is in the nodes included in the first direction subtree and the second direction subtree and whose second obstacle distance to the first virtual object is less than or equal to the collision distance is obtained, and the target obstacle region boundary is determined as the collision obstacle boundary of the first virtual object. Alternatively, an original obstacle region boundary in which the target obstacle region boundary is located is determined as the collision obstacle boundary of the first virtual object. In other words, the collision obstacle boundary of the first virtual object includes the obstacle region boundary corresponding to the root node and the obstacle region boundary found by searching the first direction subtree and the second direction subtree of the root node. A second obstacle distance corresponding to an obstacle region boundary may be a shortest distance (where the second obstacle distance may be or may not be a vertical distance) between the first virtual object and a line segment that is on the obstacle region boundary.

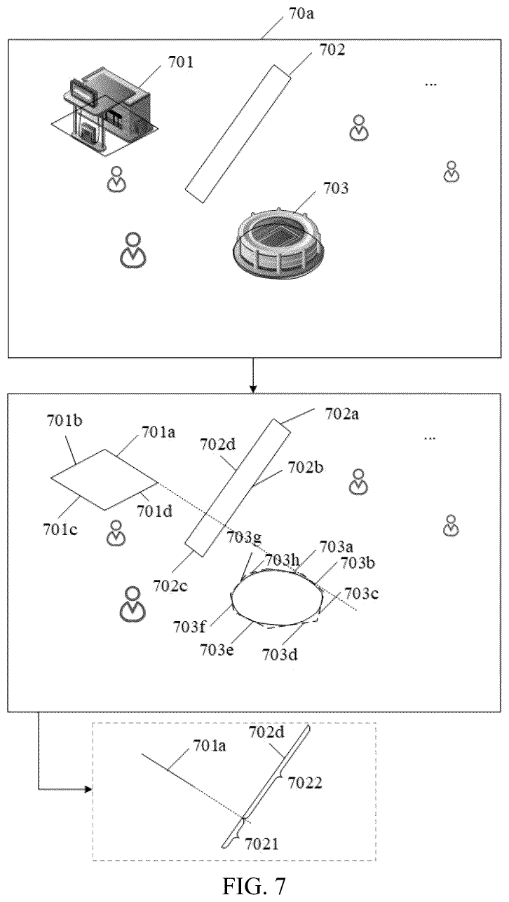

If the first obstacle distance is greater than the collision distance, a relative location relationship between the first virtual object and the obstacle region boundary corresponding to the root node is obtained. If the relative location relationship indicates that the first virtual object is located on a first directional side of the obstacle region boundary corresponding to the root node, the nodes in the first direction subtree of the root node are recursively processed until a first target node is obtained. The first target node is a node corresponding to an obstacle region boundary that is in the first direction subtree and that is on a straight line whose first obstacle distance to the first virtual object is less than or equal to the collision distance. That is, the first obstacle distance between the first virtual object and the straight line on which the obstacle region boundary corresponding to the first target node is located is less than or equal to the collision distance. An obstacle region includes a plurality of boundaries. In presentation, each obstacle region boundary may be considered as a line segment, for example, an obstacle region boundary 701a shown in FIG. 7. A straight line on which any obstacle region boundary is located is a straight line obtained by extending two ends of the obstacle region boundary. A first direction subtree and a second direction subtree of the first target node continue to be traversed, to obtain a target obstacle region boundary whose second obstacle distance to the first virtual object is less than or equal to the collision distance, and the target obstacle region boundary is determined as the collision obstacle boundary of the first virtual object. Similarly, if the relative location relationship indicates that the first virtual object is located on a second directional side of the obstacle region boundary corresponding to the root node, the nodes in the second direction subtree of the root node are recursively processed until a second target node is obtained. The second target node is a node corresponding to an obstacle region boundary that is in the second direction subtree and that is on a straight line whose first obstacle distance to the first virtual object is less than or equal to the collision distance. That is, the first obstacle distance between the first virtual object and the straight line on which the obstacle region boundary corresponding to the second target node is located is less than or equal to the collision distance. A first direction subtree and a second direction subtree of the second target node continue to be traversed, to obtain a target obstacle region boundary whose second obstacle distance to the first virtual object is less than or equal to the collision distance, and the target obstacle region boundary is determined as the collision obstacle boundary of the first virtual object.

In a process of traversing the nodes in the obstacle-space binary tree, subtrees, such as the first direction subtree and the second direction subtree, are continuously obtained and detected from the obstacle-space binary tree. The first obstacle distance is a distance between the first virtual object and a straight line on which an obstacle region boundary corresponding to a root node in a currently detected subtree is located.

A first direction subtree of a master node is a tree structure formed by nodes located on a first directional side of the master node, and is equivalent to a left subtree. A second direction subtree of the master node is a tree structure formed by nodes located on a second directional side of the master node, and is equivalent to a right subtree. For example, FIG. 6 is a schematic diagram of an obstacle-space binary tree according to an aspect of this disclosure. As shown in FIG. 6, it is assumed that a root node of the obstacle-space binary tree is a node 60a, and the node 60a corresponds to a first direction subtree 601 and a second direction subtree 602. Using a node 60b as an example, a first direction subtree of the node 60b is a tree structure including a node 60c, a node 60d, and a node 60e, and a second direction subtree of the node 60b is a tree structure including a node 60f and a node 60g. Similarly, a first direction subtree and a second direction subtree of any node in the obstacle-space binary tree may be obtained.

Further, the obstacle-space binary tree is generated based on the obstacle region boundary of the obstacle region included in the target scene. Specifically, the computer device may obtain the obstacle region included in the target scene, and obtain an original obstacle region boundary of the obstacle region. For example, FIG. 7 is a schematic diagram of a scene according to an aspect of this disclosure. As shown in FIG. 7, it is assumed that an obstacle region 701, an obstacle region 702, an obstacle region 703, and the like exist in the target scene. The obstacle region 701 includes an original obstacle region boundary 701a, an original obstacle region boundary 701b, an original obstacle region boundary 701c, and an original obstacle region boundary 701d. The obstacle region 702 includes an original obstacle region boundary 702a, an original obstacle region boundary 702b, an original obstacle region boundary 702c, an original obstacle region boundary 702d. The obstacle region 703 includes an original obstacle region boundary 703a, an original obstacle region boundary 703b, an original obstacle region boundary 703c, . . . , an original obstacle region boundary 703h, and the like. A shape (namely, contour information) of the obstacle region in the target scene may be a polygon, an arc (for example, a circle, an ellipse, or an irregular curved surface), or the like. When the shape of the obstacle region is a polygon, original obstacle region boundaries of the obstacle region, such as the obstacle region 701 and the obstacle region 702, may be obtained. When the shape of the obstacle region is an arc, an original obstacle region boundary of the obstacle region cannot be directly obtained. Polygon conversion may be performed on the obstacle region, to obtain an obstacle conversion region, and a boundary of the obstacle conversion region is determined as the original obstacle region boundary of the obstacle region, such as the obstacle region 703. Similarly, the original obstacle region boundary included in the target scene may be obtained.

Further, a first obstacle region boundary may be obtained from the original obstacle region boundary. A difference between a quantity of obstacle region boundaries located on a first directional side of the first obstacle region boundary and a quantity of obstacle region boundaries located on a second directional side of the first obstacle region boundary is less than or equal to the boundary division threshold. Any obstacle region boundary is an original obstacle region boundary located on one directional side of the first obstacle region boundary, or an obstacle region boundary obtained by segmenting original obstacle region boundaries located on two directional sides of the first obstacle region boundary. Specifically, segmentation may be performed based on the first obstacle region boundary. That an original obstacle region boundary is located on a directional side of the first obstacle region boundary means that all parts of the original obstacle region boundary are on a same side of the first obstacle region boundary. For example, using the original obstacle region boundary 701a as an example, the original obstacle region boundary 701b, the original obstacle region boundary 701c, the original obstacle region boundary 701d, the original obstacle region boundary 702c, . . . , the original obstacle region boundary 703h, and the like may be considered as original obstacle region boundaries located on a directional side of the original obstacle region boundary 701a, and the original obstacle region boundary 702d, the original obstacle region boundary 702b, and the like may be considered as original obstacle region boundaries located on two directional sides of the original obstacle region boundary 701a. Further, the first obstacle region boundary may be used as a root node, the original obstacle region boundary is divided into a first boundary set and a second boundary set by using the first obstacle region boundary, a first direction subtree of the root node is constructed based on the first boundary set, and a second direction subtree of the root node is constructed based on the second boundary set. The first boundary set includes the obstacle region boundary located on the first directional side of the first obstacle region boundary, and the second boundary set includes the obstacle region boundary located on the second directional side of the first obstacle region boundary. In some aspects, the boundary division threshold may be a preset value. Alternatively, the boundary division threshold may be determined based on a sum (which is referred to as, for example, a set quantity) of the quantity of obstacle region boundaries located on the first directional side of the first obstacle region boundary and the quantity of obstacle region boundaries located on the second directional side of the first obstacle region boundary. For example, the boundary division threshold may be 1/10 of the set quantity. This is not limited herein. A segmentation line segment (namely, the first obstacle region boundary) is selected based on the boundary division threshold, so that there is no need to traverse all the original obstacle region boundaries to search for the original obstacle region boundary used as the root node, thereby reducing construction duration of the tree structure. In this way, duration complexity of obtaining the first boundary set and the second boundary set through segmentation for a single time is reduced to N*log (N), to improve construction efficiency of the tree structure. N in the time complexity is a quantity representation of the complexity, and is different from another N. To be specific, in this disclosure, N in the time complexity is a quantity representation, and N other than N in the time complexity is the array dimension of the object management array.

When the obstacle region boundary is divided into the first boundary set and the second boundary set by using the first obstacle region boundary, the computer device may segment an original obstacle region boundary C into an obstacle region boundary C₁ and an obstacle region boundary C₂ by using a straight line on which the first obstacle region boundary is located, the obstacle region boundary C₁ being a part that is of the original obstacle region boundary C and that is located on the first directional side of the first obstacle region boundary, and the obstacle region boundary C₂ being a part that is of the original obstacle region boundary C and that is located on the second directional side of the first obstacle region boundary. As shown in FIG. 7, the original obstacle region boundary 702d may be segmented into an obstacle region boundary 7021, an obstacle region boundary 7022, and the like by using a straight line on which the original obstacle region boundary 701a is located. For a manner of segmenting the original obstacle region boundary C by using the straight line on which the first obstacle region boundary is located, refer to a manner of segmenting the original obstacle region boundary 702d in FIG. 7. Further, an obstacle region boundary A and the obstacle region boundary C₁ may be determined as the first boundary set, and an obstacle region boundary B and the obstacle region boundary C₂ are determined as the second boundary set. The obstacle region boundary A is an original obstacle region boundary on the first directional side of the first obstacle region boundary, the obstacle region boundary B is an original obstacle region boundary on the second directional side of the first obstacle region boundary, and the original obstacle region boundary C is an original obstacle region boundary on both directional sides of the first obstacle region boundary. When the first direction subtree of the root node is constructed based on the first boundary set, the foregoing process of determining the first obstacle region boundary based on the original obstacle region boundary may be repeated until the first boundary set is traversed completely. Node distribution corresponding to each obstacle region boundary in the first boundary set is determined, and the first direction subtree of the root node is determined based on the node distribution corresponding to each obstacle region boundary in the first boundary set. Similarly, the second direction subtree of the root node may be constructed based on the second boundary set. The original obstacle region boundary is a boundary constituting the obstacle region. One node corresponds to one or more obstacle region boundaries, and each obstacle region boundary may be an original obstacle region boundary constituting the obstacle region, or a part of the original obstacle region boundary obtained after the original obstacle region boundary is segmented.

In some aspects, each node in the obstacle-space binary tree may correspond to an obstacle region boundary. Alternatively, one node in the obstacle-space binary tree may correspond to a plurality of obstacle region boundaries. Specifically, if a quantity of the obstacle region boundaries A and the obstacle region boundaries C₁ is less than or equal to a tree construction threshold, the obstacle region boundary A and the obstacle region boundary C₁ are used as first direction child nodes of the root node, and the first direction child nodes of the root node are determined as the first direction subtree of the root node. If the quantity of the obstacle region boundaries A and the obstacle region boundaries C₁ is greater than the tree construction threshold, a second obstacle region boundary is obtained from the obstacle region boundary A and the obstacle region boundary C₁, the second obstacle region boundary is determined as a first direction child node of the root node, the obstacle region boundary A and the obstacle region boundary C₁ are divided into a third boundary set and a fourth boundary set based on the first direction child node, a first direction subtree of the first direction child node is constructed based on the third boundary set, and a second direction subtree of the first direction child node is constructed based on the fourth boundary set. Similarly, if a quantity of the obstacle region boundaries B and the obstacle region boundaries C₂ is less than or equal to the tree construction threshold, the obstacle region boundary B and the obstacle region boundary C₂ are used as second direction child nodes of the root node, and the second direction child nodes of the root node are determined as the second direction subtree of the root node. If the quantity of the obstacle region boundaries B and the obstacle region boundaries C₂ is greater than the tree construction threshold, a third obstacle region boundary is obtained from the obstacle region boundary B and the obstacle region boundary C₂, the third obstacle region boundary is determined as a second direction child node of the root node, the obstacle region boundary B and the obstacle region boundary C₂ are divided into a fifth boundary set and a sixth boundary set based on the second direction child node, a first direction subtree of the second direction child node is constructed based on the fifth boundary set, and a second direction subtree of the second direction child node is constructed based on the sixth boundary set. In other words, when each of the foregoing boundary sets (such as the first boundary set, the second boundary set, . . . , and the sixth boundary set) is further divided, when a quantity of obstacle region boundaries included in the boundary set is less than or equal to the tree construction threshold, the boundary set is not divided, and each obstacle region boundary included in the boundary set is directly used as a node, to further reduce a quantity of times for which the boundary set is divided, and further improve the construction efficiency of the tree structure to some extent.

In some aspects, a dynamic boundary set may further be searched, and an obstacle region boundary that may collide with the first virtual object is further searched for based on the dynamic boundary set. Specifically, if the dynamic boundary set is not empty, a dynamic region boundary is obtained from the dynamic boundary set, and a dynamic region boundary that is in the dynamic region boundary and whose distance to the first virtual object is less than or equal to the collision distance is determined as a dynamic collision boundary of the first virtual object. When the dynamic boundary set includes a dynamic obstacle region, the dynamic obstacle region may be obtained from the dynamic boundary set, and a dynamic region boundary of the dynamic obstacle region is obtained. The dynamic collision boundary and the collision region boundary may be collectively referred to as the collision obstacle boundary, that is, the dynamic collision boundary and the collision region boundary are determined as the collision obstacle boundary. The collision obstacle boundary is a boundary line that may collide with the first virtual object in a moving process of the first virtual object.

If a quantity of the dynamic region boundaries included in the dynamic boundary set is greater than or equal to a dynamic support threshold, or fixed duration of the obstacle-space binary tree is greater than or equal to a tree update cycle, the obstacle-space binary tree is reconstructed based on the nodes in the obstacle-space binary tree and the dynamic region boundaries. Alternatively, if a quantity of dynamic obstacle regions included in the dynamic boundary set is greater than or equal to the dynamic support threshold, or the fixed duration of the obstacle-space binary tree is greater than or equal to the tree update cycle (that is, the obstacle-space binary tree may be periodically updated), the obstacle-space binary tree is reconstructed based on the nodes in the obstacle-space binary tree and the dynamic region boundaries. The fixed duration is duration for which the obstacle-space binary tree remains unchanged, that is, continuous duration for which the obstacle-space binary tree remains unchanged, and is equivalent to periodically updating the obstacle-space binary tree based on the tree update cycle. Further, the dynamic boundary set is cleared, or the dynamic boundary set is deleted. In some aspects, a total quantity of obstacles in the obstacle region included in the target scene may be obtained, and the dynamic support threshold is determined based on the total quantity of obstacles. For example, when the dynamic obstacle region is greater than or equal to a specified percentage of the obstacle region, the obstacle-space binary tree is reconstructed. In other words, a product of the total quantity of obstacles and the specified percentage may be determined as the dynamic support threshold.

The dynamic region boundary may be considered as an obstacle region that is dynamically added or subtracted in the target scene. If each time the dynamic region boundary is added to the target scene, the obstacle-space binary tree is reconstructed, because reconstruction of the obstacle-space binary tree requires long duration, tree construction efficiency is low. Therefore, the dynamic region boundary may be maintained by using the dynamic boundary set. Specifically, the computer device may maintain a dynamic boundary set AS and an overall boundary set TS. The computer device associates each node in the obstacle-space binary tree with region information of an obstacle region to which an obstacle region boundary corresponding to the node belongs. The dynamic boundary set AS is configured for maintaining an obstacle region that is dynamically added or subtracted in the target scene, and the overall boundary set TS is configured for maintaining all obstacle regions in the target scene. When a first obstacle region is added to the target scene, the first obstacle region may be added to the dynamic boundary set AS and the overall boundary set TS. The first obstacle region in the dynamic boundary set AS may be referred to as a dynamic obstacle region, the first obstacle region in the overall boundary set TS may be referred to as an obstacle region, and the obstacle region includes the dynamic obstacle region. Further, when a second obstacle region is deleted from the target scene, the second obstacle region in the dynamic boundary set AS and the second obstacle region in the overall boundary set TS may be deleted. In this case, when the collision region boundary and the dynamic collision boundary are obtained, a boundary that does not belong to the overall boundary set may be deleted from the collision region boundary and the dynamic collision boundary, to obtain the collision obstacle boundary. In some aspects, the second obstacle region may be added to a to-be-deleted region set. When the collision region boundary and the dynamic collision boundary are obtained, a boundary that belongs to the to-be-deleted region set may be deleted from the collision region boundary and the dynamic collision boundary, to obtain the collision obstacle boundary. In some aspects, after the obstacle-space binary tree is reconstructed, the to-be-deleted region set may be deleted.

When the obstacle-space binary tree is reconstructed based on the nodes in the obstacle-space binary tree and the dynamic region boundaries, it may be considered that the obstacle-space binary tree is reconstructed based on region information of the obstacle region included in the overall boundary set.

In some aspects, for example, when dim is 3, when distance detection is performed on the obstacle region boundary and the dynamic region boundary, a region boundary belonging to an obstacle region whose height range does not intersect with an object height of the first virtual object may be directly deleted, to obtain a to-be-detected boundary. For example, if a height range to which an obstacle region boundary 1 belongs does not intersect with the object height of the first virtual object, the obstacle region boundary 1 may be deleted. In other words, the region boundary is the obstacle region boundary or the dynamic region boundary, or both the obstacle region boundary and the dynamic region boundary. A collision obstacle boundary whose distance to the first virtual object is less than or equal to the collision distance is obtained from the to-be-detected boundary.

Operation S303: Predict an updated moving speed of the first virtual object based on the second virtual object and the collision region boundary. For example, an updated moving speed of the first virtual object is predicted based on the second virtual object and the collision region boundary.

In this aspect of this disclosure, when the dynamic collision boundary exists, the updated moving speed of the first virtual object may be predicted based on the second virtual object, the collision region boundary of the first virtual object, and the dynamic collision boundary of the first virtual object. That is, the updated moving speed of the first virtual object is predicted based on the second virtual object and the collision obstacle boundary.

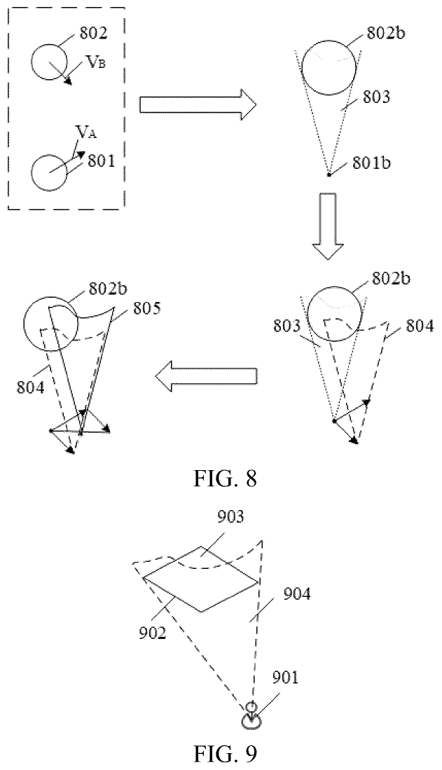

Specifically, the computer device obtains a first moving speed and first location information of the first virtual object. The computer device obtains a second moving speed and object location information of the second virtual object, constructs a first speed region based on the first location information and the object location information, and determines first offset data based on the first moving speed and the second moving speed; and constructs a second speed region based on the first offset data and the first speed region, and determines a first candidate speed range based on the second speed region. For example, FIG. 8 is a schematic diagram of a speed update scenario according to an aspect of this disclosure. As shown in FIG. 8, it is assumed that a first moving speed of a first virtual object 801 is VA, and a second moving speed of a second virtual object 802 is VB. The first virtual object 801 is reduced to a point, that is, a first virtual object 801b, based on the first location information, and the second virtual object 802 is expanded, based on object location information, to an object extended region 802b whose radius is

$${R}_{B}^{N} {R}_{B}^{N} = {R}_{A} + {R}_{B} .$$

R_{A} a space radius occupied by the first virtual object 801, and R_{B} is a space radius occupied by the second virtual object 802. A first speed region 803 is constructed based on the first location information and the object location information. The first speed region 803 may be considered as a set of a series of relative speeds at which the first virtual object 801b and the object extended region 802b may collide. In this case, the relative speed included in the first speed region 803 may be denoted as CC_{AB}. Refer to a formula \textcircled{3}:

$$C {C}_{A B} = \{ {V}_{A}^{N} \vert {λ}_{A} ∩ {B}^{N} \neq ∅ \} \qquad 3$$

As shown in the formula \textcircled{3},

$${V}_{A}^{N}$$

is configured for representing a relative speed of the first virtual object 801b relative to the second virtual object 802. λ_{A} is a ray in a direction the same as that of

$${V}_{A}^{N} ,$$

B^{N} is the object extended region 802b, and Ø is an empty set.

Further, the first offset data is determined based on the first moving speed and the second moving speed. The first offset data may include first offset data A and first offset data B. The second speed region is constructed based on the first offset data and the first speed region. The second speed region includes a second speed region A and a second speed region B. The first candidate speed range is determined based on the second speed region. Specifically, the second moving speed may be determined as the first offset data A, and the second speed region A, that is, a second speed region 804 shown in FIG. 8, is constructed based on the first offset data A and the first speed region. That is, the first offset data A is a vector indicated by the second moving speed. The first speed region 803 is moved along the first offset data A, to obtain the second speed region 804. For the second speed region 804, refer to a formula \textcircled{4}:

$${Φ}_{VO} = C {C}_{A B} ⊕ {V}_{B} \qquad 4$$

As shown in the formula \textcircled{4}, Ovo is the second speed region A, and ⊕ is vector translation. The first speed region 803 is translated by the first offset data A, which is equivalent to converting a relative speed into an absolute speed. In other words, when a moving speed of the first virtual object belongs to the second speed region A, the first virtual object may collision with the second virtual object.

Further, the first offset data B may be determined based on the first moving speed and the second moving speed. For example, the first offset data B may be determined based on a half of a vector sum of the first moving speed and the second moving speed. Alternatively, the first offset data B may be determined based on the first moving speed and the second speed region A. The first offset data B is configured for moving an endpoint of the second speed region A to the half of the vector sum of the first moving speed and the second moving speed. The second speed region B (namely, a second speed region 805) is constructed based on the first offset data B and the second speed region A. The first offset data B is configured for constraining a speed at a next moment to be a half of a sum of the first moving speed and any speed that does not belong to the second speed region A, to adapt to movement at the next moment. Because the speed at the next moment is selected in various manners, a speed direction may be continuously changed and a jitter phenomenon may occur, affecting simulation realness. A change of the speed direction is constrained by using the first offset data B, to improve the simulation realness, that is, improves accuracy and realness of speed prediction. For the second speed region B, refer to a formula \textcircled{5}:

$${Φ}_{R V O} = \{ {V}_{A}^{R V O} \vert 2 {V}_{A}^{R V O} - {V}_{A} ∈ {Φ}_{V O} \} \qquad 5$$

As shown in the formula \textcircled{5}, Φ_{RVO} is the second speed region B.

$${V}_{A}^{R V O}$$

is a speed included in the second speed region B. Further, the first candidate speed range is determined based on the second speed region B. The first candidate speed range is a speed range indicated by a region not belonging to the second speed region B.

Alternatively, when the first offset data is determined based on the first moving speed and the second moving speed, and the second speed region is constructed based on the first offset data and the first speed region, a half of a vector sum of the first moving speed and the second moving speed may be directly determined as the first offset data, and translation processing is performed on the first speed region based on the first offset data, to obtain the second speed region. Further, the first candidate speed range is determined based on the second speed region. The first candidate speed range is a speed range indicated by a region not belonging to the second speed region.

Further, a boundary moving speed and boundary location information of the collision region boundary of the first virtual object is obtained, a third speed region is constructed based on the first location information and the boundary location information, and second offset data is determined based on the first moving speed and the boundary moving speed; and a fourth speed region is constructed based on the second offset data and the third speed region, and a second candidate speed range is determined based on the fourth speed region. Alternatively, when the dynamic collision boundary exists, the boundary moving speed and the boundary location information of the collision obstacle boundary are obtained, the third speed region is constructed based on the first location information and the boundary location information, and the second offset data is determined based on the first moving speed and the boundary moving speed; and the fourth speed region is constructed based on the second offset data and the third speed region, and the second candidate speed range is determined based on the fourth speed region. For a manner of constructing the third speed region, refer to the manner of constructing the first speed region, and for a manner of constructing the fourth speed region, refer to the manner of constructing the second speed region. Details are not described herein again. The second moving speed in the process of constructing the first speed region is replaced with the boundary moving speed, to obtain a process of constructing the third speed region. The second moving speed in the process of constructing the second speed region is replaced with the boundary moving speed, to obtain a process of constructing the fourth speed region. The boundary moving speed may be considered as 0.

In some aspects, when the third speed region is constructed based on the first location information and the boundary location information, the third speed region may be constructed by using the first location information as a circle center and by using a tangent line from the circle center to contour information of an obstacle region indicated by the boundary location information. FIG. 9 is a schematic diagram of a scenario of constructing a speed region according to an aspect of this disclosure. As shown in FIG. 9, a third speed region 904 is constructed by using first location information 901 as a circle center and by using a tangent line from the circle center to contour information of an obstacle region 903 indicated by boundary location information of a collision obstacle boundary 902. Offset for the third speed region and the like is the same as above. In this manner, because implementation is based on the obstacle region, region integration may be performed on the collision obstacle boundary, to obtain the collision obstacle region corresponding to the collision obstacle boundary, and the fourth speed region is directly constructed for the first virtual object and the collision obstacle region, to reduce an amount of data that needs to be processed for speed prediction, and improve speed prediction efficiency.

Further, an intersection of the first candidate speed range and the second candidate speed range is determined as a target candidate speed range of the first virtual object. Alternatively, a union of the second speed region and the fourth speed region is determined as a total speed region, and a region other than the total speed region is determined as a target candidate speed range of the first virtual object. A quantity of the second virtual objects may be p, and a quantity of the collision obstacle boundaries is q, where p is a positive integer, and q is a positive integer. An intersection of first candidate speed ranges respectively corresponding to the p second virtual objects and second candidate speed ranges respectively corresponding to the q collision obstacle boundaries may be determined as the target candidate speed range of the first virtual object. Alternatively, a union of second speed regions respectively corresponding to the p second virtual objects and fourth speed regions respectively corresponding to the q collision obstacle boundaries may be determined as a total speed region, and a region other than the total speed region is determined as the target candidate speed range of the first virtual object. Because the candidate speed range is a broad range, speed regions may be integrated first, and then the target candidate speed range is determined, to improve speed determining efficiency. Further, the updated moving speed of the first virtual object may be selected from the target candidate speed range. In some aspects, an adjacent passing region of the first location information (namely, a passable region adjacent to the first location information) may be obtained, and a speed update direction is determined based on the adjacent passing region and a moving direction of the first moving speed. A speed change range of the first virtual object is determined based on the first moving speed and a maximum acceleration of the first virtual object. The updated moving speed of the first virtual object is determined based on the speed update direction and the speed change range. A direction of the updated moving speed belongs to the speed update direction, and a value of the updated moving speed belongs to the speed change range. In this process, movement of the first virtual object at a next moment is maintained in a passable region of the target scene, and a sudden speed change does not occur, to improve accuracy, rationality, and realness of speed prediction. Alternatively, the updated moving speed of the first virtual object may be directly selected from the target candidate speed range.

Operation S304: Control, based on the updated moving speed, the first virtual object to move. For example, movement of the first virtual object is controlled based on the updated moving speed.

In this aspect of this disclosure, the first virtual object is controlled based on the updated moving speed to move. In some aspects, in operation S303, when the updated moving speed vel is directly obtained, an initial path plan may be determined based on the updated moving speed vel, and the initial path plan may be denoted as vel*Δt. The initial path plan may be offset based on the adjacent passing region of the first location information, to obtain an offset path plan. The first virtual object is controlled based on the offset path plan to move, to keep the first virtual object located in the passable region of the target scene.

In some aspects, if a quantity of the obstacle region boundaries of the obstacle region included in the target scene is less than or equal to a tree construction threshold, distances between the obstacle region boundaries and the first virtual object are obtained, and an obstacle region boundary that is in the obstacle region boundaries and whose distance to the first virtual object is less than or equal to the collision distance is determined as the collision region boundary of the first virtual object. If the quantity of the obstacle region boundaries of the obstacle region included in the target scene is greater than the tree construction threshold, the process of obtaining the obstacle-space binary tree of the target scene in which the first virtual object is located is performed. In other words, when the quantity of the obstacle region boundaries of the obstacle region included in the target scene is small, the obstacle-space binary tree does not need to be constructed, to save resources and improve management efficiency of the binary tree.

In the aspects of this disclosure, the candidate virtual object located in the initial collision cache region of the first virtual object may be obtained, the second virtual object associated with the first virtual object is obtained from the candidate virtual object, and the candidate virtual object of the first virtual object is broadly stored by using the cache. This is equivalent to initial virtual-object screening. When the initial collision cache region is cached, the initial collision cache region is broadly stored, that is, preset. When the second virtual object is obtained, searching duration is reduced, and virtual-object screening efficiency is improved. In addition, the obstacle-space binary tree of the target scene in which the first virtual object is located may be obtained, the nodes in the obstacle-space binary tree are traversed, and the target obstacle region boundary corresponding to the node whose distance to the first virtual object is less than or equal to the collision distance is determined as the collision region boundary of the first virtual object. The node in the obstacle-space binary tree corresponds to the obstacle region boundary in the target scene. The difference between the quantity of obstacle region boundaries included in the first direction subtree corresponding to any node in the obstacle-space binary tree and the quantity of obstacle region boundaries included in the second direction subtree corresponding to the node is less than or equal to the boundary division threshold. In other words, quantities of child nodes of any node in the obstacle-region binary tree in two directions are similar. Therefore, when the obstacle-space binary tree is traversed, screening in a direction may be performed based on the direction, so that efficiency of screening the obstacle region is improved. Further, the updated moving speed of the first virtual object may be predicted based on the obtained second virtual object and the collision region boundary, and the first virtual object is controlled based on the updated moving speed to move. According to the foregoing process, efficiency of the operations of obtaining the updated moving speed is improved, to further improve pathfinding efficiency.

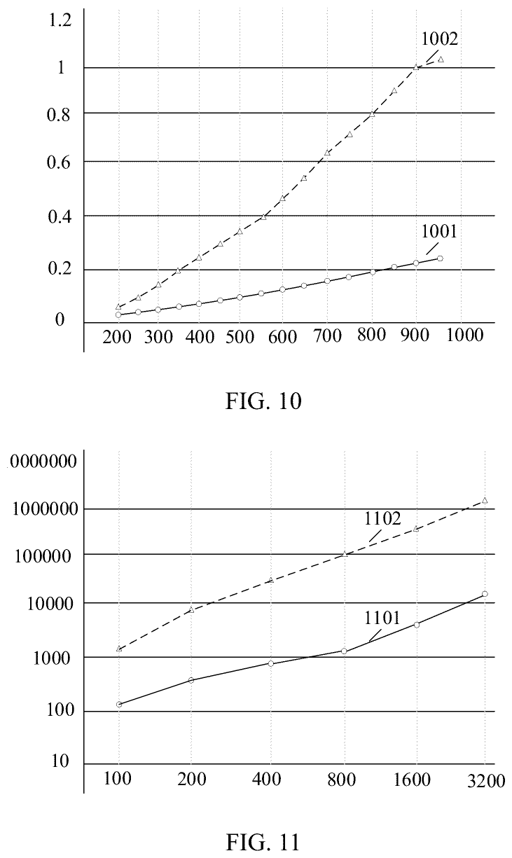

An experimental scenario is used as an example. The experimental scenario is a circle having a radius of 1000, U virtual objects having a radius of 1 are evenly distributed on the circle, a collision distance of each virtual object is 10, and a standard moving speed is 5. Each virtual object needs to move to a location with an angle offset of 150 degrees in the circle, and latest location information and an initial collision cache region are calculated every 0.1 second during movement. After all the virtual objects arrive at the specified location, calculation of the initial collision cache region is stopped. Complete iteration duration of a related algorithm and complete iteration duration of this disclosure are counted under different Us, to obtain a test result shown in FIG. 10. FIG. 10 is a schematic diagram of iteration duration according to an aspect of this disclosure. As shown in FIG. 10, a test result 1001 is the complete iteration duration of this disclosure, and a test result 1002 is the complete iteration duration of the related algorithm. It may be learned that the complete iteration duration is greatly reduced, and efficiency of constructing an initial collision cache region is improved by approximately four times, so that a quantity of virtual objects that can be carried by same calculation resources is also improved by approximately four times.

Further, a plurality of squares with rotation (namely, dynamic obstacle regions) are generated in various manners in the experimental scenario. FIG. 11 is a schematic diagram of a tree-construction test result according to an aspect of this disclosure. As shown in FIG. 11, a horizontal axis is a quantity of squares, a vertical axis is construction duration of an obstacle-space binary tree, and a logarithmic coordinate axis is used in the vertical axis. For example, a test result 1101 is construction duration of the obstacle-space binary tree in this disclosure, and a test result 1102 is construction duration of an obstacle-space binary tree in a related algorithm. It can be learned that this disclosure is non-strict balanced division, and the related algorithm is strict balanced division. It can be learned that time complexity of the strict balanced division is greater than time complexity of the non-strict balanced division by a constant of a quantity U of squares. That is, this disclosure reduces time complexity of construction of the obstacle-space binary tree, and improves tree construction efficiency. In this disclosure, time complexity of constructing the initial collision cache region is a constant times of a quantity of virtual objects, and time complexity of constructing the obstacle-space binary tree is also a constant times of a quantity of obstacle regions. Therefore, when an entire system is not congested, duration required for running is simply and positively correlated to the quantity of virtual objects and the quantity of obstacle regions in the target scene (including the experimental scenario), and performance expandability is very good.

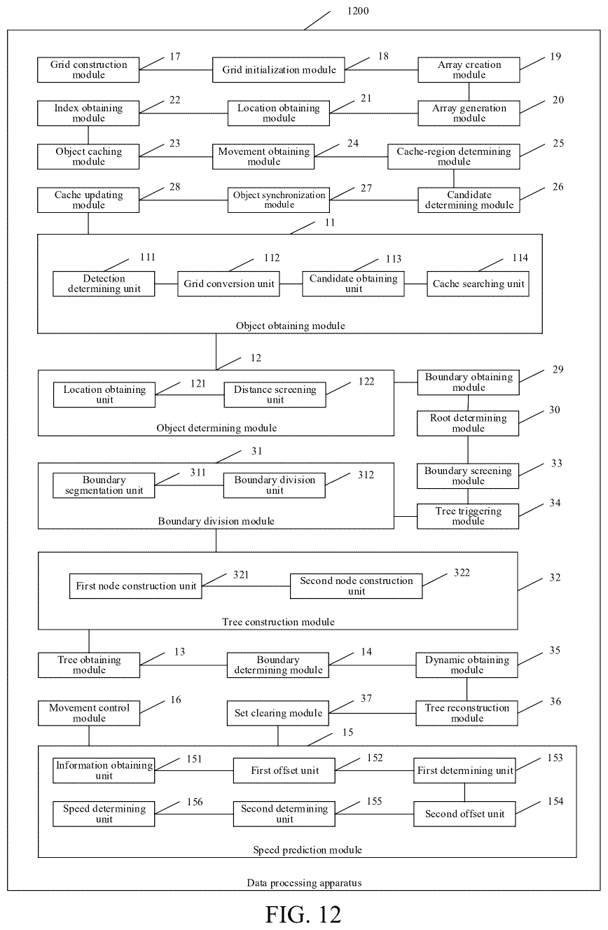

Further, FIG. 12 is a schematic diagram of a data processing apparatus according to an aspect of this disclosure. The data processing apparatus may be a computer program (including program code and the like) run in a computer device. For example, the data processing apparatus may be application software. The apparatus may be configured to perform corresponding operations in the method provided in the aspects of this disclosure. As shown in FIG. 12, the data processing apparatus 1200 may be used in the computer device in the aspect corresponding to FIG. 3. Specifically, the apparatus may include an object obtaining module 11, an object determining module 12, a tree obtaining module 13, a boundary determining module 14, a speed prediction module 15, and a movement control module 16.

The object obtaining module 11 is configured to obtain candidate virtual objects located in an initial collision cache region of a first virtual object.

The object determining module 12 is configured to obtain, from the candidate virtual objects, a second virtual object associated with the first virtual object, a distance between the second virtual object and the first virtual object being less than or equal to a collision distance of the first virtual object, the initial collision cache region being a to-be-detected grid index corresponding to the first virtual object in an object management array, the object management array being configured for representing a grid index corresponding to a virtual object included in a target scene, the grid index being configured for representing a location of the virtual object in a unit grid into which the target scene is divided, the target scene including the first virtual object, and the candidate virtual object being a virtual object in an array element indicated by the to-be-detected grid index in the object management array.

The tree obtaining module 13 is configured to obtain an obstacle-space binary tree of the target scene in which the first virtual object is located.

The boundary determining module 14 is configured to traverse nodes in the obstacle-space binary tree, and determine, as a collision region boundary of the first virtual object, a target obstacle region boundary corresponding to a node whose distance to the first virtual object is less than or equal to the collision distance, the node in the obstacle-space binary tree corresponding to an obstacle region boundary in the target scene, a difference between a quantity of obstacle region boundaries included in a first direction subtree of any node in the obstacle-space binary tree and a quantity of obstacle region boundaries included in a second direction subtree of the node being less than or equal to a boundary division threshold, and the obstacle region boundary being a boundary line of an obstacle region existing in the target scene.

The speed prediction module 15 is configured to predict an updated moving speed of the first virtual object based on the second virtual object and the collision region boundary.

The movement control module 16 is configured to control, based on the updated moving speed, the first virtual object to move.

The object obtaining module 11 includes:
a detection determining unit 111, configured to obtain first location information of the first virtual object and the collision distance of the first virtual object, and fuse the first location information and the collision distance, to obtain a collision detection range of the first virtual object;
a grid conversion unit 112, configured to obtain a unit length of the unit grid of the target scene, and perform grid conversion on the collision detection range based on the unit length, to obtain a grid detection range; and
a candidate obtaining unit 113, configured to perform Hash conversion on the grid detection range, to obtain the initial collision cache region of the first virtual object, and determine, as the candidate virtual object, a virtual object corresponding to the initial collision cache region in the object management array.

The apparatus 1200 further includes:
a grid construction module 17, configured to construct the target scene into M unit grids based on the unit length of the unit grid;
a grid initialization module 18, configured to initialize grid location information respectively corresponding to the M unit grids, M being a positive integer;
an array creation module 19, configured to create an N-dimensional initial object management array, and perform Hash conversion on the grid location information respectively corresponding to the M unit grids, to obtain grid indexes respectively corresponding to the M unit grids, N being a positive integer; and
an array generation module 20, configured to obtain the unit grid in which the virtual object included in the target scene is located, and add the virtual object to the initial object management array based on a grid index of the unit grid in which the virtual object is located, to obtain the object management array, the initial collision cache region being a grid index obtained based on conversion of the grid detection range, and the virtual object including the candidate virtual object.

The grid initialization module 18 is specifically configured to:
obtain second location information of grid identification points respectively corresponding to the M unit grids, and perform location gridding conversion, based on the unit length, on the second location information respectively corresponding to the M unit grids, to obtain the grid location information respectively corresponding to the M unit grids.

The apparatus 1200 further includes:
a location obtaining module 21, configured to: when a third virtual object enters the target scene, obtain third location information of the third virtual object in the target scene;
an index obtaining module 22, configured to perform grid conversion on the third location information based on the unit length, to obtain an object grid location of the third virtual object, and perform Hash conversion on the object grid location, to obtain a to-be-added grid index corresponding to the third virtual object; and
an object caching module 23, configured to add the third virtual object to the object management array based on the to-be-added grid index.

The object obtaining module 11 includes:
a cache searching unit 114, configured to obtain the candidate virtual objects from a collision object cache associated with the first virtual object, the collision object cache being configured for storing a virtual object located in the initial collision cache region of the first virtual object.

The apparatus 1200 further includes:
a movement obtaining module 24, configured to: when the first virtual object joins the target scene, obtain a standard moving speed and the collision distance of the first virtual object;
a cache-region determining module 25, configured to determine the initial collision cache region of the first virtual object based on the standard moving speed and the collision distance;
a candidate determining module 26, configured to determine, as the candidate virtual object associated with the first virtual object, the virtual object included in the initial collision cache region, and add the candidate virtual object to the collision object cache associated with the first virtual object; and
an object synchronization module 27, configured to add the first virtual object to a collision object cache of the candidate virtual object.

The apparatus 1200 further includes:
a cache updating module 28, configured to: if cache duration of the collision object cache of the first virtual object reaches a cache update cycle or location jumping occurs on the first virtual object, clear the collision object cache of the first virtual object, obtain a current collision cache region of the first virtual object, and add a virtual object included in the current collision cache region to the collision object cache of the first virtual object, the location jumping being that the first virtual object changes from a first location to a second location at a speed greater than a teleportation speed threshold.

The object determining module 12 includes:
a location obtaining unit 121, configured to obtain candidate location information of the candidate virtual objects, and obtain first location information of the first virtual object; and
a distance screening unit 122, configured to calculate an object location distance between the candidate location information and the first location information, and if the object location distance is less than or equal to the collision distance, determine the candidate virtual object as the second virtual object associated with the first virtual object, the second virtual object including no first virtual object.

The apparatus 1200 further includes:
a boundary obtaining module 29, configured to obtain the obstacle region included in the target scene, obtain an original obstacle region boundary of the obstacle region, and obtain a first obstacle region boundary from the original obstacle region boundary, a difference between a quantity of obstacle region boundaries located on a first directional side of the first obstacle region boundary and a quantity of obstacle region boundaries located on a second directional side of the first obstacle region boundary being less than or equal to the boundary division threshold, and any obstacle region boundary being an original obstacle region boundary located on one directional side of the first obstacle region boundary, or an obstacle region boundary obtained by segmenting original obstacle region boundaries located on two directional sides of the first obstacle region boundary;
a root determining module 30, configured to use the first obstacle region boundary as a root node;
a boundary division module 31, configured to divide the original obstacle region boundary into a first boundary set and a second boundary set by using the first obstacle region boundary; and
a tree construction module 32, configured to construct a first direction subtree of the root node based on the first boundary set, and construct a second direction subtree of the root node based on the second boundary set, the first boundary set including the obstacle region boundary located on the first directional side of the first obstacle region boundary, and the second boundary set including the obstacle region boundary located on the second directional side of the first obstacle region boundary.

The boundary division module 31 includes:
a boundary segmentation unit 311, configured to segment an original obstacle region boundary C into an obstacle region boundary C₁ and an obstacle region boundary C₂ by using a straight line on which the first obstacle region boundary is located, the obstacle region boundary C₁ being a part that is of the original obstacle region boundary C and that is located on the first directional side of the first obstacle region boundary, and the obstacle region boundary C₂ being a part that is of the original obstacle region boundary C and that is located on the second directional side of the first obstacle region boundary; and
a boundary division unit 312, configured to determine an obstacle region boundary A and the obstacle region boundary C₁ as the first boundary set, and determine an obstacle region boundary B and the obstacle region boundary C₂ as the second boundary set, the obstacle region boundary A being an original obstacle region boundary on the first directional side of the first obstacle region boundary, the obstacle region boundary B being an original obstacle region boundary on the second directional side of the first obstacle region boundary, and the original obstacle region boundary C being an original obstacle region boundary on both directional sides of the first obstacle region boundary.

The tree construction module 32 includes:
a first node construction unit 321, configured to: if a quantity of the obstacle region boundaries A and the obstacle region boundaries C₁ is less than or equal to a tree construction threshold, use the obstacle region boundary A and the obstacle region boundary C₁ as first direction child nodes of the root node, and determine the first direction child nodes of the root node as the first direction subtree of the root node; and
a second node construction unit 322, configured to: if the quantity of the obstacle region boundaries A and the obstacle region boundaries C₁ is greater than the tree construction threshold, obtain a second obstacle region boundary from the obstacle region boundary A and the obstacle region boundary C₁, determine the second obstacle region boundary as a first direction child node of the root node, divide the obstacle region boundary A and the obstacle region boundary C₁ into a third boundary set and a fourth boundary set based on the first direction child node, construct a first direction subtree of the first direction child node based on the third boundary set, and construct a second direction subtree of the first direction child node based on the fourth boundary set.

The apparatus 1200 further includes:
a boundary screening module 33, configured to: if a quantity of the obstacle region boundaries of the obstacle region included in the target scene is less than or equal to a tree construction threshold, obtain distances between the obstacle region boundaries and the first virtual object, and determine, as the collision region boundary of the first virtual object, an obstacle region boundary that is in the obstacle region boundaries and whose distance to the first virtual object is less than or equal to the collision distance; and
a tree triggering module 34, configured to: if the quantity of the obstacle region boundaries of the obstacle region included in the target scene is greater than the tree construction threshold, notify the tree obtaining module 13 to perform the process of obtaining the obstacle-space binary tree of the target scene in which the first virtual object is located.

The apparatus 1200 further includes:
a dynamic obtaining module 35, configured to: if a dynamic boundary set is not empty, obtain a dynamic region boundary from the dynamic boundary set, and determine, as a dynamic collision boundary of the first virtual object, a dynamic region boundary that is in the dynamic region boundary and whose distance to the first virtual object is less than or equal to the collision distance; and
a speed prediction module 15, configured to predict the updated moving speed of the first virtual object based on the second virtual object, the collision region boundary of the first virtual object, and the dynamic collision boundary of the first virtual object.

The dynamic obtaining module 35 is alternatively configured to notify the speed prediction module 15 to predict the updated moving speed of the first virtual object based on the second virtual object and the collision region boundary.

The apparatus 1200 further includes:
a tree reconstruction module 36, configured to: if a quantity of the dynamic region boundaries included in the dynamic boundary set is greater than or equal to a dynamic support threshold, or fixed duration of the obstacle-space binary tree is greater than or equal to a tree update cycle, reconstruct the obstacle-space binary tree based on the nodes in the obstacle-space binary tree and the dynamic region boundaries; and
a set clearing module 37, configured to clear the dynamic boundary set.

The speed prediction module 15 includes:
an information obtaining unit 151, configured to obtain a first moving speed and first location information of the first virtual object;
a first offset unit 152, configured to obtain a second moving speed and object location information of the second virtual object, construct a first speed region based on the first location information and the object location information, and determine first offset data based on the first moving speed and the second moving speed;
a first determining unit 153, configured to construct a second speed region based on the first offset data and the first speed region, and determine a first candidate speed range based on the second speed region;
a second offset unit 154, configured to obtain a boundary moving speed and boundary location information of the collision region boundary of the first virtual object, construct a third speed region based on the first location information and the boundary location information, and determine second offset data based on the first moving speed and the boundary moving speed;
a second determining unit 155, configured to construct a fourth speed region based on the second offset data and the third speed region, and determine a second candidate speed range based on the fourth speed region; and
a speed determining unit 156, configured to determine an intersection of the first candidate speed range and the second candidate speed range as a target candidate speed range of the first virtual object, and select the updated moving speed of the first virtual object from the target candidate speed range.

In the aspects of this disclosure, the candidate virtual object located in the initial collision cache region of the first virtual object may be obtained, the second virtual object associated with the first virtual object is obtained from the candidate virtual object, and the candidate virtual object of the first virtual object is broadly stored by using the cache. This is equivalent to initial virtual-object screening. The initial collision cache region is the to-be-detected grid index corresponding to the first virtual object in the object management array, and the object management array is configured for representing the location that is of the virtual object included in the target scene and that is in the unit grid into which the target scene is divided, so that a computer device can conveniently and quickly index the candidate virtual object in the object management array, to further reduce searching duration required for obtaining the second virtual object, and improve virtual-object screening efficiency. In addition, the unit grid is obtained through dividing based on only the location in the target scene, and is not affected by a terrain layout of the target scene, so that generation of the unit grid does not need to be changed for many times, and the unit grid can even be applied to different scenes. Therefore, construction efficiency and convenience of the unit grid can be improved. In addition, the obstacle-space binary tree of the target scene in which the first virtual object is located may be obtained, the nodes in the obstacle-space binary tree are traversed, and the target obstacle region boundary corresponding to the node whose distance to the first virtual object is less than or equal to the collision distance is determined as the collision region boundary of the first virtual object. The node in the obstacle-space binary tree corresponds to the obstacle region boundary in the target scene. A difference between a quantity of first direction child nodes corresponding to any node in the obstacle-space binary tree and a quantity of second direction child nodes corresponding to the node is less than or equal to the boundary division threshold. In other words, quantities of child nodes of any node in the obstacle-region binary tree in two directions are similar. Therefore, traversing on the obstacle-space binary tree is similar to binary search, so that efficiency of screening the obstacle region is improved. Further, the updated moving speed of the first virtual object may be predicted based on the obtained second virtual object and the collision region boundary, and the first virtual object is controlled based on the updated moving speed to move. According to the foregoing process, efficiency of the operations of obtaining the updated moving speed is improved, to further improve pathfinding efficiency.

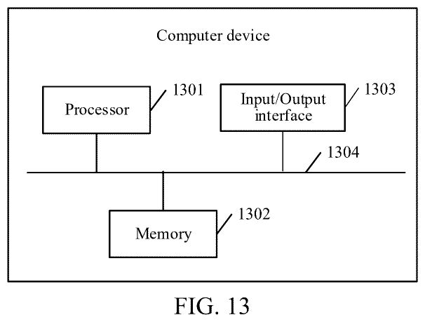

FIG. 13 is a schematic diagram of a structure of a computer device according to an aspect of this disclosure. As shown in FIG. 13, the computer device in this aspect of this disclosure may include one or more processors 1301 (e.g., processing circuitry), a memory 1302 (e.g., a non-transitory computer-readable storage medium), and an input/output interface 1303. The processor 1301, the memory 1302, and the input/output interface 1303 are connected through a bus 1304. The memory 1302 is configured to store a computer program, and the computer program includes program instructions. The input/output interface 1303 is configured to receive data and output data, for example, configured to perform data exchange between computer devices. The processor 1301 is configured to execute the program instructions stored in the memory 1302.

The processor 1301 may perform the following operations:
obtaining candidate virtual objects located in an initial collision cache region of a first virtual object, and obtaining, from the candidate virtual objects, a second virtual object associated with the first virtual object, a distance between the second virtual object and the first virtual object being less than or equal to a collision distance of the first virtual object, the initial collision cache region being a to-be-detected grid index corresponding to the first virtual object in an object management array, the object management array being configured for representing a grid index corresponding to a virtual object included in a target scene, the grid index being configured for representing a location of the virtual object in a unit grid into which the target scene is divided, the target scene including the first virtual object, and the candidate virtual object being a virtual object in an array element indicated by the to-be-detected grid index in the object management array;
obtaining an obstacle-space binary tree of the target scene in which the first virtual object is located, traversing nodes in the obstacle-space binary tree, and determining, as a collision region boundary of the first virtual object, a target obstacle region boundary corresponding to a node whose distance to the first virtual object is less than or equal to the collision distance, the node in the obstacle-space binary tree corresponding to an obstacle region boundary in the target scene, a difference between a quantity of obstacle region boundaries included in a first direction subtree of any node in the obstacle-space binary tree and a quantity of obstacle region boundaries included in a second direction subtree of the node being less than or equal to a boundary division threshold, and the obstacle region boundary being a boundary line of an obstacle region existing in the target scene; and
predicting an updated moving speed of the first virtual object based on the second virtual object and the collision region boundary, and controlling, based on the updated moving speed, the first virtual object to move.

In some feasible implementations, the processor 1301 may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The memory 1302 may include a read-only memory (ROM) and a random access memory (RAM), and provides instructions and data to the processor 1301 and the input/output interface 1303. A part of the memory 1302 may further include a non-volatile random access memory. For example, the memory 1302 may further store information about a device type.

During specific implementation, the computer device may perform implementations provided by the operations in FIG. 3 by using built-in functional modules of the computer device. For details, refer to the implementations provided by the operations in FIG. 3. Details are not described herein again.

An aspect of this disclosure provides a computer device, including a processor, an input/output interface, and a memory. A computer program in the memory is obtained by using the processor, the operations in the method shown in FIG. 3 are performed, and a data processing operation is performed. In the aspects of this disclosure, the candidate virtual object located in the initial collision cache region of the first virtual object may be obtained, the second virtual object associated with the first virtual object is obtained from the candidate virtual object, and the candidate virtual object of the first virtual object is broadly stored by using the cache. This is equivalent to initial virtual-object screening. The initial collision cache region is the to-be-detected grid index corresponding to the first virtual object in the object management array, and the object management array is configured for representing the location that is of the virtual object included in the target scene and that is in the unit grid into which the target scene is divided, so that a computer device can conveniently and quickly index the candidate virtual object in the object management array, to further reduce searching duration required for obtaining the second virtual object, and improve virtual-object screening efficiency. In addition, the unit grid is obtained through dividing based on only the location in the target scene, and is not affected by a terrain layout of the target scene, so that generation of the unit grid does not need to be changed for many times, and the unit grid can even be applied to different scenes. Therefore, construction efficiency and convenience of the unit grid can be improved. In addition, the obstacle-space binary tree of the target scene in which the first virtual object is located may be obtained, the nodes in the obstacle-space binary tree are traversed, and the target obstacle region boundary corresponding to the node whose distance to the first virtual object is less than or equal to the collision distance is determined as the collision region boundary of the first virtual object. The node in the obstacle-space binary tree corresponds to the obstacle region boundary in the target scene. A difference between a quantity of first direction child nodes corresponding to any node in the obstacle-space binary tree and a quantity of second direction child nodes corresponding to the node is less than or equal to the boundary division threshold. In other words, quantities of child nodes of any node in the obstacle-region binary tree in two directions are similar. Therefore, traversing on the obstacle-space binary tree is similar to binary search, so that efficiency of screening the obstacle region is improved. Further, the updated moving speed of the first virtual object may be predicted based on the obtained second virtual object and the collision region boundary, and the first virtual object is controlled based on the updated moving speed to move. According to the foregoing process, efficiency of the operations of obtaining the updated moving speed is improved, to further improve pathfinding efficiency.

An aspect of this disclosure further provides a computer-readable storage medium, such as a non-transitory computer-readable storage medium. The computer-readable storage medium stores a computer program. The computer program is configured for being loaded and executed by a processor, to perform the data processing method provided by the operations in FIG. 3. For details, refer to the implementations provided by the operations in FIG. 3. Details are not described herein again. In addition, for descriptions of beneficial effects of using the same method, details are not described herein again. For technical details not disclosed in the aspect of the computer-readable storage medium involved in this disclosure, refer to the descriptions of the method aspects of this disclosure. In an example, the computer program may be deployed on a computer device for execution, or may be executed on a plurality of computer devices located at a same position. Alternatively, the computer program is executed on a plurality of computer devices that are connected through a communication network and that are distributed at a plurality of locations.

The computer-readable storage medium may be an internal storage unit in the data processing apparatus provided in any one of the foregoing aspects or the computer device, for example, a hard disk or an internal memory in the computer device. The computer-readable storage medium may alternatively be an external storage device of the computer device, for example, a plug-in hard disk disposed in the computer device, a smart memory card (SMC), a security digital (SD) card, or a flash card. Further, the computer-readable storage medium may alternatively include both an internal storage unit and an external storage device of the computer device. The computer-readable storage medium is configured to store a computer program and another program and data required by the computer device. The computer-readable storage medium may be further configured to temporarily store data that has been outputted or that is to be outputted.

An aspect of this disclosure provides a computer program product or a computer program. The computer program product or the computer program includes computer instructions, and the computer instructions are stored in a computer-readable storage medium such as a non-transitory computer-readable storage medium. A processor of a computer device reads the computer instructions from the computer-readable storage medium, and the processor executes the computer instruction, so that the computer device performs the method provided in FIG. 3, to implement the following operations: The candidate virtual object located in the initial collision cache region of the first virtual object may be obtained, the second virtual object associated with the first virtual object is obtained from the candidate virtual object, and the candidate virtual object of the first virtual object is broadly stored by using the cache. This is equivalent to initial virtual-object screening. The initial collision cache region is the to-be-detected grid index corresponding to the first virtual object in the object management array, and the object management array is configured for representing the location that is of the virtual object included in the target scene and that is in the unit grid into which the target scene is divided, so that a computer device can conveniently and quickly index the candidate virtual object in the object management array, to further reduce searching duration required for obtaining the second virtual object, and improve virtual-object screening efficiency. In addition, the unit grid is obtained through dividing based on only the location in the target scene, and is not affected by a terrain layout of the target scene, so that generation of the unit grid does not need to be changed for many times, and the unit grid can even be applied to different scenes. Therefore, construction efficiency and convenience of the unit grid can be improved. In addition, the obstacle-space binary tree of the target scene in which the first virtual object is located may be obtained, the nodes in the obstacle-space binary tree are traversed, and the target obstacle region boundary corresponding to the node whose distance to the first virtual object is less than or equal to the collision distance is determined as the collision region boundary of the first virtual object. The node in the obstacle-space binary tree corresponds to the obstacle region boundary in the target scene. A difference between a quantity of first direction child nodes corresponding to any node in the obstacle-space binary tree and a quantity of second direction child nodes corresponding to the node is less than or equal to the boundary division threshold. In other words, quantities of child nodes of any node in the obstacle-region binary tree in two directions are similar. Therefore, traversing on the obstacle-space binary tree is similar to binary search, so that efficiency of screening the obstacle region is improved. Further, the updated moving speed of the first virtual object may be predicted based on the obtained second virtual object and the collision region boundary, and the first virtual object is controlled based on the updated moving speed to move. According to the foregoing process, efficiency of the operations of obtaining the updated moving speed is improved, to further improve pathfinding efficiency.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The terms “first”, “second”, and the like in the specification, the claims, and the accompanying drawings of the aspects of this disclosure are intended to distinguish between different objects, instead of describing a particular sequence. In addition, the term “including”, or any other variant thereof is intended to cover a non-exclusive inclusion. For example, a process, a method, an apparatus, a product, or a device including a series of steps or units is not limited to the listed steps or modules, but instead, in some aspects, includes steps or modules that are not listed, or in some aspects, includes other steps or units inherent to the process, method, apparatus, product, or device.

A person of ordinary skill in the art may be aware that, in combination with the examples described in the aspects disclosed in this specification, units and algorithm steps may be implemented by electronic hardware or a combination of computer software and electronic hardware. To describe interchangeability between the hardware and the software, compositions and operations of each example are described in the foregoing descriptions based on functions. Whether the functions are performed by hardware or software depends on particular applications and design constraints of the technical solutions. A person skilled in the art may implement the described function by using different methods for each particular application, but such implementation is not to be considered to go beyond the scope of this disclosure.

The method and the related apparatus provided in the aspects of this disclosure are described with reference to the method flowcharts and/or the schematic diagrams of the structures provided in the aspects of this disclosure. Specifically, each procedure and/or block in the method flowcharts and/or the schematic diagrams of the structures and a combination of a procedure and/or a block in the flowcharts and/or the block diagrams may be implemented by using computer program instructions. The computer program instructions may be provided to a general-purpose computer, a dedicated computer, an embedded processing machine, or a processor of another programmable data processing device, to generate a machine, so that the instructions executed by the computer or the processor of the another programmable data processing device generate an apparatus configured to implement the functions specified in one or more processes of the flowcharts and/or one or more blocks of the schematic diagrams of the structures. The computer program instructions may alternatively be stored in a computer-readable memory that can guide a computer or another programmable data processing device to operate in a specific manner, so that the instructions stored in the computer-readable memory generate an artifact including an instruction apparatus. The instruction apparatus implements the functions specified in one or more processes of the flowcharts and/or one or more blocks of the schematic diagrams of the structures. The computer program instructions may alternatively be loaded onto a computer or another programmable data processing device, so that a series of operations are performed on the computer or the another programmable device to generate processing implemented by a computer. Therefore, the instructions executed on the computer or the another programmable device provide operations for implementing the functions specified in one or more processes of the flowcharts and/or one or more blocks of the schematic diagrams of the structures.

The operations in the method in the aspects of this disclosure may be sequentially adjusted, combined, or deleted based on an actual requirement.

The modules in the apparatus in the aspects of this disclosure may be combined, divided, or deleted based on an actual requirement.

What is disclosed above is merely example aspects of this disclosure, and are not intended to limit the scope of this disclosure. Equivalent variations shall fall within the scope of this disclosure.

What is claimed is:

1. A data processing method, comprising:
obtaining candidate virtual objects located in an initial collision cache region of a first virtual object in a target scene;
obtaining, from the candidate virtual objects, a second virtual object at a distance from the first virtual object that is less than or equal to a collision distance of the first virtual object;
obtaining an obstacle-space binary tree of the target scene;
determining a collision region boundary of the first virtual object by traversing nodes in the obstacle-space binary tree, each of the nodes corresponding to an obstacle region boundary including a boundary line of an obstacle region in the target scene;
predicting, by processing circuitry, an updated moving speed of the first virtual object based on the second virtual object and the collision region boundary; and
controlling movement of the first virtual object based on the updated moving speed.

2. The method according to claim 1, wherein
the initial collision cache region includes to-be-detected grid indexes indicating the candidate virtual objects of the first virtual object in an object management array,
the target scene is divided into unit grids,
the object management array stores grid indexes corresponding to virtual objects in the target scene, and each grid index indicates a location of a corresponding virtual object in a unit grid.

3. The method according to claim 1, wherein the determining the collision region boundary comprises:
identifying a target obstacle region boundary corresponding to a node of the nodes in the obstacle-space binary tree having a distance to the first virtual object that is less than or equal to the collision distance; and
for each node in the obstacle-space binary tree, a difference between a quantity of obstacle region boundaries in a first direction subtree and a quantity in a second direction subtree is less than or equal to a boundary division threshold.

4. The method according to claim 2, wherein the obtaining the candidate virtual objects comprises:
obtaining first location information of the first virtual object and the collision distance of the first virtual object;
determining a collision detection range of the first virtual object based on the first location information and the collision distance;
obtaining a unit length of the unit grid of the target scene;
performing grid conversion on the collision detection range based on the unit length to obtain a grid detection range; and
performing Hash conversion on the grid detection range to obtain the to-be-detected grid indexes of the first virtual object.

5. The method according to claim 4, further comprising:
dividing the target scene into M unit grids based on the unit length of the unit grid, M being a positive integer;
initializing grid location information respectively corresponding to the M unit grids;
creating an N-dimensional initial object management array, N being a positive integer;
performing Hash conversion on the grid location information respectively corresponding to the M unit grids to obtain grid indexes respectively corresponding to the M unit grids; and
adding the virtual objects in the target scene to the N-dimensional initial object management array based on a grid index of the unit grid in which the virtual objects are located, to obtain the object management array.

6. The method according to claim 5, wherein the initializing the grid location information respectively corresponding to the M unit grids comprises:
obtaining second location information of grid identification points respectively corresponding to the M unit grids; and
performing location gridding conversion on the second location information respectively corresponding to the M unit grids based on the unit length to obtain the grid location information respectively corresponding to the M unit grids.

7. The method according to claim 5, further comprising:
when a third virtual object enters the target scene:
obtaining third location information of the third virtual object in the target scene;
performing grid conversion on the third location information based on the unit length, to determine an object grid location of the third virtual object;
performing Hash conversion on the object grid location, to obtain to-be-added grid indexes corresponding to the third virtual object; and
adding the third virtual object to the object management array based on the to-be-added grid indexes.

8. The method according to claim 1, wherein the obtaining the candidate virtual objects comprises:
obtaining the candidate virtual objects from a collision object cache associated with the first virtual object.

9. The method according to claim 8, further comprising:
when the first virtual object enters the target scene:
obtaining a standard moving speed and the collision distance of the first virtual object, the standard moving speed being a maximum moving speed of the first virtual object in a cache update cycle;
determining the initial collision cache region of the first virtual object based on the standard moving speed and the collision distance;
determining, as the candidate virtual objects associated with the first virtual object, the virtual objects included in the initial collision cache region;
adding the candidate virtual objects to the collision object cache associated with the first virtual object; and
adding the first virtual object to a collision object cache of the candidate virtual objects.

10. The method according to claim 8, further comprising:
determining when either:
cache duration for the collision object cache of the first virtual object reaches a cache update cycle, or
location jumping occurs on the first virtual object, the location jumping occurs when the first virtual object moves from a first location to a second location at a speed greater than a teleportation speed threshold;
clearing the collision object cache of the first virtual object;
obtaining a current collision cache region of the first virtual object; and
adding any virtual objects included in the current collision cache region to the cleared collision object cache.

11. The method according to claim 1, wherein the obtaining, from the candidate virtual objects, the second virtual object comprises:
obtaining candidate location information of the candidate virtual objects;
obtaining first location information of the first virtual object;
calculating a distance between the candidate location information and the first location information; and
when the distance is less than or equal to the collision distance, determining the candidate virtual object as the second virtual object.

12. The method according to claim 3, further comprising:
obtaining the obstacle region included in the target scene;
obtaining an original obstacle region boundary of the obstacle region;
obtaining a first obstacle region boundary from the original obstacle region boundary, a difference between a quantity of obstacle region boundaries located on a first directional side of the first obstacle region boundary and a quantity of obstacle region boundaries located on a second directional side of the first obstacle region boundary being less than or equal to the boundary division threshold;
using the first obstacle region boundary as a root node;
dividing the original obstacle region boundary into a first boundary set and a second boundary set by using the first obstacle region boundary;
constructing a first direction subtree of the root node based on the first boundary set; and
constructing a second direction subtree of the root node based on the second boundary set.

13. The method according to claim 12, wherein the dividing the original obstacle region boundary comprises:
segmenting an original obstacle region boundary C into an obstacle region boundary C₁ and an obstacle region boundary C₂ by using a straight line on which the first obstacle region boundary is located, the obstacle region boundary C₁ being a part that is of the original obstacle region boundary C and that is located on the first directional side of the first obstacle region boundary, and the obstacle region boundary C₂ being a part that is of the original obstacle region boundary C and that is located on the second directional side of the first obstacle region boundary; and
determining an obstacle region boundary A and the obstacle region boundary C₁ as the first boundary set, and determining an obstacle region boundary B and the obstacle region boundary C₂ as the second boundary set, the obstacle region boundary A being an original obstacle region boundary on the first directional side of the first obstacle region boundary, the obstacle region boundary B being an original obstacle region boundary on the second directional side of the first obstacle region boundary, and the original obstacle region boundary C being an original obstacle region boundary on both directional sides of the first obstacle region boundary.

14. The method according to claim 13, wherein the constructing the first direction subtree of the root node comprises:
when a quantity of the obstacle region boundaries A and the obstacle region boundaries C₁ is less than or equal to a tree construction threshold, using the obstacle region boundary A and the obstacle region boundary C₁ as first direction child nodes of the root node, and determining the first direction child nodes of the root node as the first direction subtree of the root node; and
when the quantity of the obstacle region boundaries A and the obstacle region boundaries C₁ is greater than the tree construction threshold, obtaining a second obstacle region boundary from the obstacle region boundary A and the obstacle region boundary C₁, determining the second obstacle region boundary as a first direction child node of the root node, dividing the obstacle region boundary A and the obstacle region boundary C₁ into a third boundary set and a fourth boundary set based on the first direction child node, constructing a first direction subtree of the first direction child node based on the third boundary set, and constructing a second direction subtree of the first direction child node based on the fourth boundary set.

15. The method according to claim 1, further comprising:
when a quantity of the obstacle region boundaries of the obstacle region included in the target scene is less than or equal to a tree construction threshold, obtaining distances between the obstacle region boundaries and the first virtual object, and determining, as the collision region boundary of the first virtual object, an obstacle region boundary that is in the obstacle region boundaries and whose distance to the first virtual object is less than or equal to the collision distance; and
when the quantity of the obstacle region boundaries of the obstacle region included in the target scene is greater than the tree construction threshold, obtaining an obstacle-space binary tree of the target scene in which the first virtual object is located.

16. The method according to claim 1, further comprising:
when a dynamic boundary set is not empty:
obtaining one or more dynamic region boundaries from the dynamic boundary set,
determining, as dynamic collision boundaries of the first virtual object, the obtained one or more dynamic region boundaries having a distance to the first virtual object that is less than or equal to the collision distance, and
predicting the updated moving speed of the first virtual object based on the second virtual object, the collision region boundary of the first virtual object, and the dynamic collision boundaries of the first virtual object; and
when the dynamic boundary set is empty:
predicting the updated moving speed of the first virtual object based on the second virtual object and the collision region boundary.

17. The method according to claim 16, wherein when either:
a quantity of the dynamic region boundaries in the dynamic boundary set is greater than or equal to a dynamic support threshold, or
fixed duration of the obstacle-space binary tree is greater than or equal to a tree update cycle,
the method further comprises:
reconstructing the obstacle-space binary tree based on the nodes in the obstacle-space binary tree and the dynamic region boundaries; and
clearing the dynamic boundary set after the reconstruction.

18. The method according to claim 1, wherein the predicting the updated moving speed of the first virtual object comprises:
obtaining a first moving speed and first location information of the first virtual object;
obtaining a second moving speed and object location information of the second virtual object, constructing a first speed region based on the first location information and the object location information, and determining first offset data based on the first moving speed and the second moving speed;
constructing a second speed region based on the first offset data and the first speed region, and determining a first candidate speed range based on the second speed region;
obtaining a boundary moving speed and boundary location information of the collision region boundary of the first virtual object, constructing a third speed region based on the first location information and the boundary location information, and determining second offset data based on the first moving speed and the boundary moving speed;
constructing a fourth speed region based on the second offset data and the third speed region, and determining a second candidate speed range based on the fourth speed region; and
determining an intersection of the first candidate speed range and the second candidate speed range as a target candidate speed range of the first virtual object, and selecting the updated moving speed of the first virtual object from the target candidate speed range.

19. A data processing apparatus, comprising:
processing circuitry configured to:
obtain candidate virtual objects located in an initial collision cache region of a first virtual object in a target scene;
obtain, from the candidate virtual objects, a second virtual object at a distance from the first virtual object that is less than or equal to a collision distance of the first virtual object;
obtain an obstacle-space binary tree of the target scene;
determine a collision region boundary of the first virtual object by traversing nodes in the obstacle-space binary tree, each of the nodes corresponding to an obstacle region boundary including a boundary line of an obstacle region in the target scene;
predict an updated moving speed of the first virtual object based on the second virtual object and the collision region boundary; and
control movement of the first virtual object based on the updated moving speed.

20. A non-transitory computer-readable storage medium storing instructions which, when executed by a processor, cause the processor to perform:
obtaining candidate virtual objects located in an initial collision cache region of a first virtual object in a target scene;
obtaining, from the candidate virtual objects, a second virtual object at a distance from the first virtual object that is less than or equal to a collision distance of the first virtual object;
obtaining an obstacle-space binary tree of the target scene;
determining a collision region boundary of the first virtual object by traversing nodes in the obstacle-space binary tree, each of the nodes corresponding to an obstacle region boundary including a boundary line of an obstacle region in the target scene;
predicting an updated moving speed of the first virtual object based on the second virtual object and the collision region boundary; and
controlling movement of the first virtual object based on the updated moving speed.
